(19) United States
(12) Patent Application Publication
(10) Pub. No.: US 2026/0230473 A1
(43) Pub. Date: Aug. 6, 2026

(54) SYSTEM AND METHOD FOR ASSOCIATING DEVICES ACROSS MOBILE, WI-FI HOTSPOT AND HOME NETWORKS

(71) Applicant: CABLE TELEVISION LABORATORIES, INC., Louisville, CO (US)

(72) Inventors: Tao Wan, Ottawa (CA); Darshak Thakore, Broomfield, CA (US); Rahil Gandotra, Boulder, CO (US); Neeharika Jesukumar, Snoqualmie, WA (US); Brian A. Scriber, Lafayette, CO (US); Luther E. Smith, Fort Lupton, CO (US)

(73) Assignee: CABLE TELEVISION LABORATORIES, INC., Louisville, CO (US)

(21) Appl. No.: 19/532,760

(22) Filed: Feb. 6, 2026

Related U.S. Application Data
(60) Provisional application No. 63/755,181, filed on Feb. 6, 2025.

(51) Int. Cl. H04L 9/40

(52) U.S. Cl. CPC H04L 63/0876; H04L 63/0892

(57) ABSTRACT

Examples of associating devices across mobile, Wi-Fi hotspot and home networks are provided. A first network node generates an access request message, including one or more device identifiers including: a Medium Access Control (MAC) address for the device, an Internet Protocol (IP) address for the device, a network access identifier (NAI) for the device, a first Institute of Electrical and Electronics Engineers (IEEE) 802.11bh device identifier (device ID) for the device, a mobile subscription identifier, or a fingerprint for the device. The first network node sends, to a second network node, the access request message. The second network node receives, from the first network node, the access request message, and forwards, to a third network node, the access request message. The third network node receives, from the second network node, the access request message. The third network node allocates a second IEEE 802.11bh device identifier for the device.

### CROSS-REFERENCE TO RELATED APPLICATION

This application claims the benefit of U.S. Provisional Application No. 63/755,181, filed Feb. 6, 2025, the contents of which are incorporated herein by reference.

### BACKGROUND

A user equipment (UE) may access different access networks. For example, a UE may access a Third Generation Partnership Project (3GPP) mobile network, such as a Fifth Generation (5G) or Sixth Generation (6G) wireless network. The same UE may also access a Wi-Fi network, such as using a Wi-Fi hotspot. Moreover, the UE may access a cable network at the home of the user of the UE. A multiple-system operator (MSO) may be in communication with the UE via any one of, or a combination, of the 3GPP mobile network, the Wi-Fi network and the home cable network.

Traditionally, MSOs offer internet connectivity services to households regardless of the type of consumer devices inside a house. Because users interact directly with devices and not with residential gateways, user experiences with the network are often determined by how their devices perform and connect to networks. Device-level services have been the model used by the mobile industry, where a seamless connectivity experience is achieved by service procedures between devices and networks.

### SUMMARY

Systems and methods for associating devices across mobile, Wi-Fi hotspot and home networks are provided herein. In an example, a first network node generates an access request message. In an example, the access request message includes one or more device identifiers including: a Medium Access Control (MAC) address for the device, an Internet Protocol (IP) address for the device, a network access identifier (NAI) for the device, a first Institute of Electrical and Electronics Engineers (IEEE) 802.11bh device identifier (device ID) for the device, a mobile subscription identifier, or a fingerprint for the device. Further, the first network node sends, to a second network node, the access request message.

Also, the second network node receives, from the first network node, the access request message, and forwards, to a third network node, the access request message. In addition, the third network node receives, from the second network node, the access request message.

Additionally or alternatively, the third network node allocates, based on network policy and on a determination that no subscription of the device is found, a second IEEE 802.11bh device identifier for the device. Additionally or alternatively, the second IEEE 802.11bh device identifier for the device is a network wide identifier. Further, the third network node generates an access response message. Additionally or alternatively, the access response message includes the second IEEE 802.11bh identifier for the device. Additionally or alternatively, the third network node sends, to the second network node, the access response message.

Additionally or alternatively, the second network node receives, from the third network node, the access response message, and forwards, to the first network node, the access response message. Additionally or alternatively, the first network node receives, from the second network node, the access response message. Additionally or alternatively, the first network node stores the second IEEE 802.11bh device identifier for the device and associates the second IEEE 802.11bh device identifier for the device with the first IEEE 802.11bh device identifier for the device or a MAC information element (IE) for the device.

Additionally or alternatively, the first network node is a Wi-Fi router, the second network node is a proxy, the third network node is an identification management function (IdMF), and the device is a user equipment (UE). Additionally or alternatively, the Wi-Fi router includes an access point (AP), and the UE is a Wi-Fi device. Additionally or alternatively, the proxy is an authentication, authorization, accounting (AAA) proxy, and a fourth network node is used in between the second network node and the third network node.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of a residential gateway (RG) of a one-box model;

FIG. 6 illustrates an example of an RG of a two-box model;

FIG. 7 illustrates an example of a one-box model RG, a user-owned access point (AP) and an optional ethernet switch;

FIG. 8 illustrates an example of a two-box model RG, a user-owned access point (AP) and an optional ethernet switch;

FIG. 9 illustrates an example of a one-box model RG, a Wi-Fi Mesh and an optional ethernet switch;

FIG. 10 illustrates an example of a two-box model RG, a Wi-Fi Mesh and an optional ethernet switch;

FIG. 11 illustrates an example of a one-box model RG and a Wi-Fi Mesh using the same service set identifier (SSID), controlled and steered by a Wi-Fi controller;

FIG. 12 illustrates an example of a two-box model RG and a Wi-Fi Mesh using the same SSID, controlled and steered by a Wi-Fi controller;

FIG. 13 illustrates an example of network architecture converged with a 5G core network;

FIG. 14 illustrates an example of a protocol stack for a control plane for extensible authentication protocol (EAP)-based authentication of Wi-Fi devices directly connected to a Wi-Fi router;

FIG. 15 illustrates an example of a protocol stack for a user plane for Wi-Fi devices connected directly to the Wi-Fi router;

FIG. 16 illustrates an example of different subscription databases in a multiple-system operator (MSO) network;

FIG. 17 illustrates an example of an association function to identify a device across network subscription databases;

FIG. 18 illustrates an example of a procedure for authenticating a Wi-Fi device by the 5GC;

FIG. 19 illustrates an example of a procedure for authenticating a Wi-Fi device by an authentication, authorization, accounting (AAA) server;

FIG. 20 illustrates an example of a procedure for authenticating a Wi-Fi device supporting an Institute of Electrical and Electronics Engineers (IEEE) 802.11bh device identifier;

FIG. 21 illustrates an example of a procedure for authenticating a Wi-Fi device supporting IEEE 802.11bh Identifiable Random Medium Access Control (MAC) (IRM); and

FIG. 22 illustrates an example of a procedure for authenticating a Wi-Fi device without IEEE 802.11bh capability.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A User Equipment (UE) may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

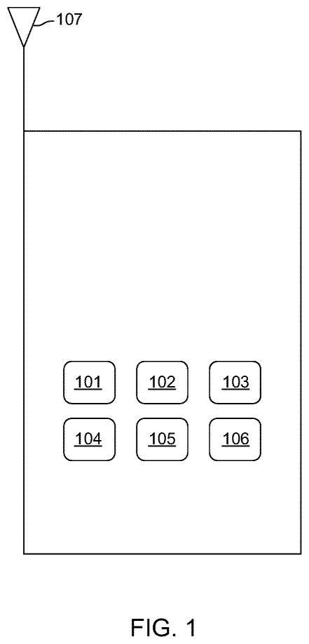

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.).

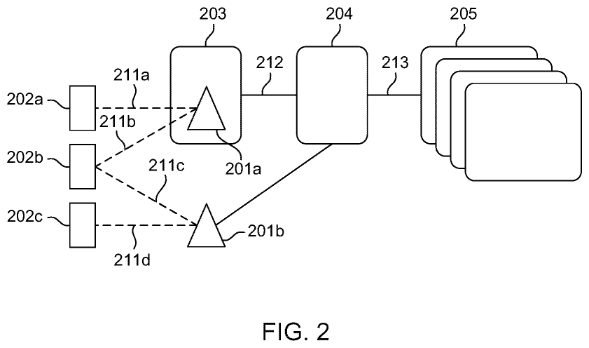

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

A base station may be a network node. Other network nodes may be located in a network, including the core network. A network node may communicate over a wired connection, over a wireless connection, or over both. A network node may include a processor and a communications interface. A network node may be or may include a network function (NF).

Generally, a communication system may use a combination of wired and wireless connections at different points in the system. One or more wireless technologies (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMFs, one or more UPFs, one or more Session Management Functions (SMFs), and/or one or more Data Networks (DNS). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the Internet protocol (IP) in the TCP/IP internet protocol suite.

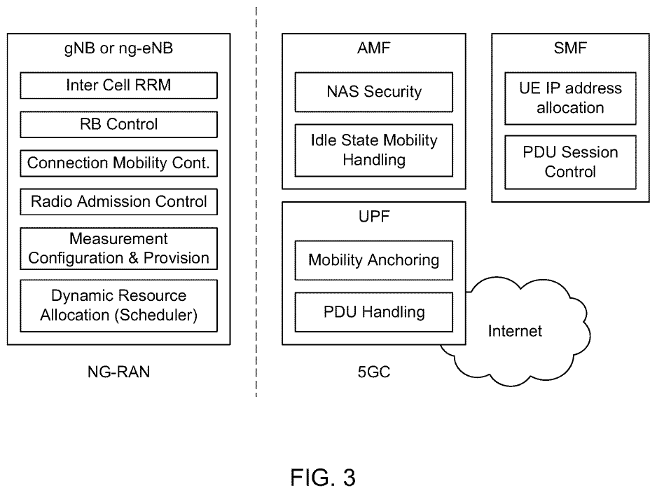

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

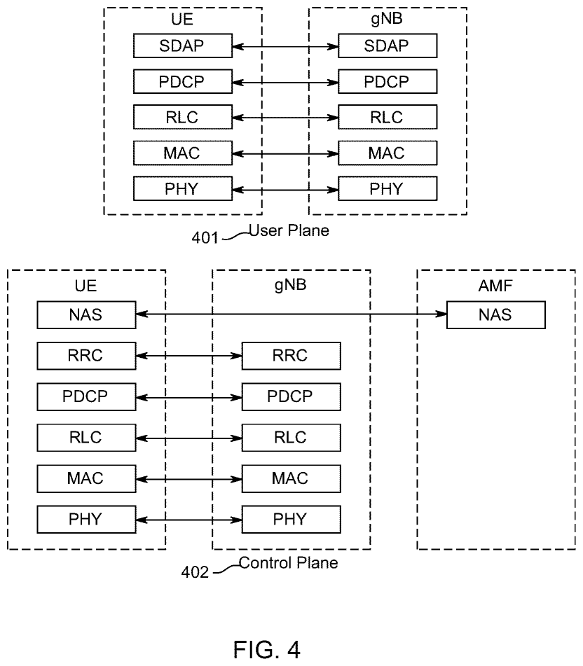

FIG. 4 illustrates an example of a protocol stack for the user plane and control plane. The user plane protocol stack 401 and the control plane stack 402 are shown in an example in FIG. 4. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be 4G, CBRS, cdma2000, 6G, 802.11, Wi-Fi, wireline (Ethernet), and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

An RG is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may be non-3GPP capable, in which case it is referred to as a Fixed Network RG (FN-RG). The 5G-RG may play the role of a UE.

While reference to 5GC is mentioned to assist in explaining the concepts of the embodiments and examples provided herein, these embodiments and examples are equally applicable to other generations of wireless technologies, and may be interchangeable with 3G, 4G, 6G, etc.

There are benefits to both users and operators to allow RGs, and devices that are non-3GPP capable and are behind RGs, to access the 3GPP 5G 5GC. The 5GC provides several features that may be beneficial, independent of the type of access technology used by the devices accessing the network. Users may receive the benefits of the rich 5G features, and operators may have means to charge for the usage of such features.

As an example, there may be one or more procedures that enable access to the Evolved Packet Core (EPC) or the 5GC via non-3GPP RATs. One such example is a UE accessing the 5GC using WLAN.

Additionally, there may be one or more procedures for supporting access to the 5GC via a wireline AN. As an example, a home LAN may be connected to the 5GC via an RG. The RG may contain functionality that enables devices behind it to connect with the 5GC and obtain 5G services.

The 5G-RG and the W-AGF may interface with the 5GC Control Plane (CP) and the 5GC User Plane (UP) functions, via N2 and N3 interfaces, respectively. They may enable authentication, registration and packet data network (PDN) connectivity procedures associated with the devices behind the RG. They may facilitate the provisioning of differentiated services to the devices behind the RG, via the interfaces with the 5GC.

As used herein, an authentication, authorization, accounting (AAA) proxy is an entity that acts as a AAA server toward a AAA client and as a AAA client toward a AAA server. It receives a service request from a AAA client and forwards the request to a AAA server in the next hop toward the AAA server in the ultimate destination. It also receives a service response from a AAA server and forwards it toward the AAA client originating the request.

As used herein, an AP is a device instantiates the required Institute of Electrical and Electronics Engineers (IEEE) 802.11 physical and MAC layer functions, including security functions such as authentication, confidentiality, and integrity protection, as defined in IEEE 802.11-2023. A cable modem is a device that implements the data over cable interface specification (DOCSIS) protocols to provide bidirectional data communications via HFC infrastructure. A Wi-Fi router is a device that is integrated with a Wi-Fi AP and offers IP layer functions such as IP forwarding, network address translation, and Dynamic Host Configuration Protocol (DHCP).

As noted above, a device may connect to a network using a wireline (e.g., Ethernet), Wi-Fi, or cellular (e.g., 4G, 5G) connection. Three types of Wi-Fi networks (specifically, each Wi-Fi network is a wireless local area network, or WLAN) that a device may connect to are described herein, including private residential Wi-Fi networks, public Wi-Fi hotspot networks, and community Wi-Fi networks.

A Wi-Fi AP obtains IP connectivity via an access network. Based on the underlying technologies, an access network can be based on hybrid fiber-coax (HFC), Passive Optical Network (PON), etc. These access networks may be traditional or virtualized. Because an access network provides connectivity to a Wi-Fi access point (AP) to which a device directly connects without directly interacting with other end-user devices, the access network does not have an impact on the identification and authentication of end-user devices. Thus, embodiments and examples provided herein use HFC (cable modem (CM) and cable modem termination system (CMTS)) as an example access network in architecture diagrams without further elaboration on the access network itself.

Examples of residential networks are provided below. An RG consists of a CM and a Wi-Fi router. In an example, the RG may be an operator controlled RG. The RG may operate in a residential network. The RG connects a LAN in a residential area to an operator's IP network. A Wi-Fi router provides both layer 2 and layer 3 functions. For layer 2 functions, the router may provide both wireless interfaces (e.g., Wi-Fi interfaces) and wired interfaces (e.g., Ethernet). Layer 3 functions include IP address assignments, network address translation (NAT), IP forwarding, and others. An RG may be either a one-box or a two-box model depending on the operator's preference.

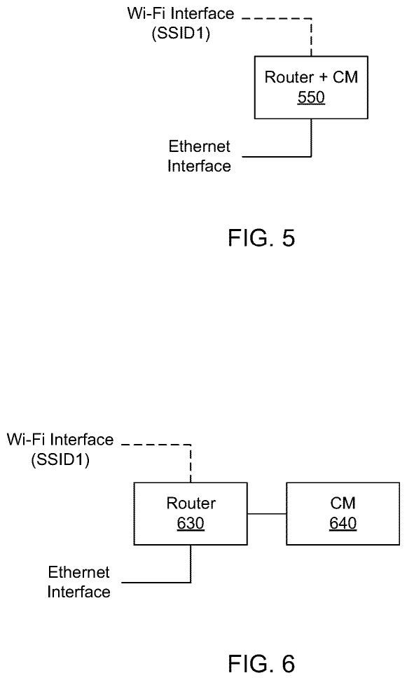

FIG. 5 illustrates an example of an RG of a one-box model. In a one-box model, both the router and CM are integrated inside one physical box 550, as shown in an example in FIG. 5. The router and CM 550 have Wi-Fi access via an Wi-Fi interface, with a first service set identifier (SSID) shown as SSID1, and Ethernet access via an Ethernet interface.

FIG. 6 illustrates an example of an RG of a two-box model. In a two-box model, the router 630 and the CM 640 are in two separate physical boxes, connected by wireline (e.g., Ethernet). The router 630 has Wi-Fi access via an Wi-Fi interface (SSID1) and Ethernet access via an Ethernet interface.

In both one-box and two-box models, in embodiments and examples herein, the router can be managed and configured by the operator. Further, in both one-box and two-box models, the RG (or router and CM) is either provided by the operator or bought by a user and is compliant with operator requirements, thus allowing the operator to directly control and configure the RG.

Examples of user-controlled Wi-Fi APs are provided herein. In addition to the operator-controlled RG in the home, a user may have bought additional network devices to extend Wi-Fi coverage inside the home, including APs, repeaters, and extenders.

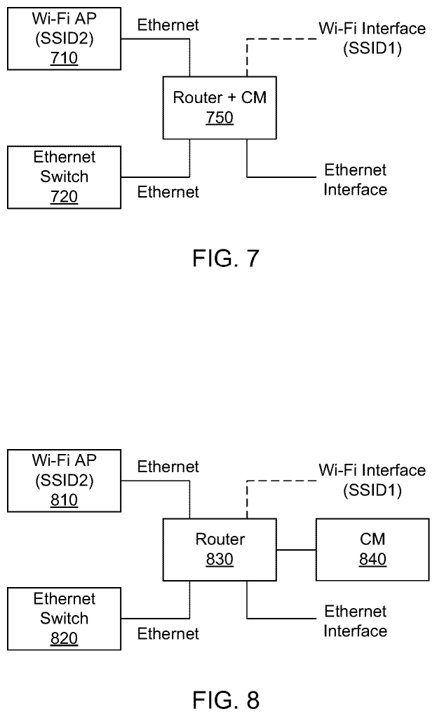

Those Wi-Fi APs can be bought by an end user from open market or from an operator. The Wi-Fi APs can be connected to the RG in different ways. First, an AP can be connected to the RG via wireline (e.g., Ethernet), as shown in FIG. 7 and FIG. 8, below. Second, an AP can be connected to the RG via wireless (e.g., Wi-Fi). In addition, the user may also have Ethernet switch connecting to the RG via wireline (e.g., Ethernet). User devices (e.g., desktop) can connect to the Ethernet switch via Ethernet to gain access to the RG and the network.

Wi-Fi extenders can also be deployed to improve Wi-Fi signal coverage inside a home. Since a Wi-Fi extender only amplifies Wi-Fi signals without changing any Wi-Fi frames or functions, it does not have any impact on device identification and authentication.

Examples of separate Wi-Fi networks are provided herein. A user-controlled AP and operator-controlled APs within the RG create two or more separate Wi-Fi networks. For example, the user-owned AP and the operator-controlled RG may use two different SSIDs and different passwords for authentication. Further, an Ethernet switch is optional, and there may be some requirement on the Ethernet switch to support extensible authentication protocol (EAP) authentication of devices connecting to the switch. Examples including optional Ethernet switches are shown in FIGS. 7 through 10, below.

FIG. 7 illustrates an example of a one-box model RG, a user-owned access point (AP) and an optional ethernet switch. As a one-box model, both the router and CM are integrated inside one physical box 750. The router and CM 750 are operator-controlled and have Wi-Fi access via an Wi-Fi interface using SSID1, and Ethernet access via an Ethernet interface. Further, the router and CM 750 have Ethernet access to a user-owned Wi-Fi AP 710 using SSID2. As seen, SSID2 is an SSID different from SSID1. Moreover, the router and CM 750 have Ethernet access via Ethernet switch 720.

FIG. 8 illustrates an example of a two-box model RG, a user-owned access point (AP) and an optional ethernet switch. As a two-box model, the router 830 and the CM 840 are in two separate physical boxes, connected by wireline (e.g., Ethernet). The operator-controlled router 830 has Wi-Fi access via an Wi-Fi interface (SSID1) and Ethernet access via an Ethernet interface. Further, the router 830 has Ethernet access to a user-owned Wi-Fi AP 810 in using SSID2. As in the above example, SSID2 is an SSID different from SSID1. Moreover, the router 830 has Ethernet access via Ethernet switch 820.

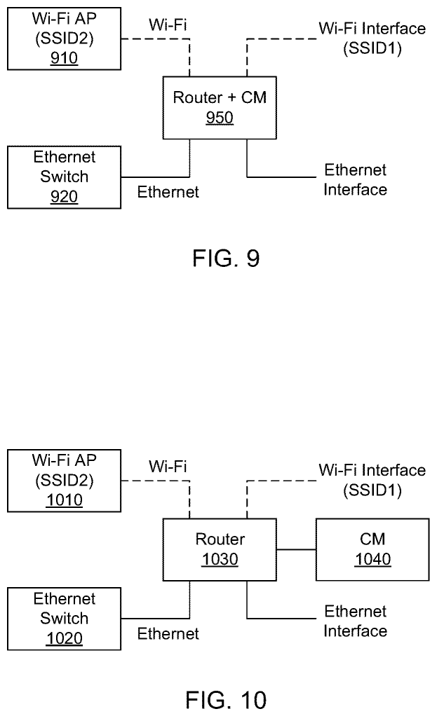

FIG. 9 illustrates an example of a one-box model RG, a Wi-Fi Mesh and an optional ethernet switch. As a one-box model, both the router and CM are integrated inside one physical box 950. The router and CM 950 are operator-controlled and have Wi-Fi access via an Wi-Fi interface using SSID1, and Ethernet access via an Ethernet interface. Further, the router and CM 950 have Wi-Fi access to a user-owned Wi-Fi AP 910 in a mesh network using SSID2. As seen, SSID2 is an SSID different from SSID1. Moreover, the router and CM 950 have Ethernet access via Ethernet switch 920.

FIG. 10 illustrates an example of a two-box model RG, a Wi-Fi Mesh and an optional ethernet switch. Again, the router 1030 and the CM 1040 are in two separate physical boxes, connected by wireline (e.g., Ethernet). The operator-controlled router 1030 has Wi-Fi access via an Wi-Fi interface (SSID1) and Ethernet access via an Ethernet interface. Further, the router 1030 has Wi-Fi access to a user-owned Wi-Fi AP 1010 in a mesh network using SSID2 (SSID2 is an SSID different from SSID1). Moreover, the router 1030 has Ethernet access via Ethernet switch 1020.

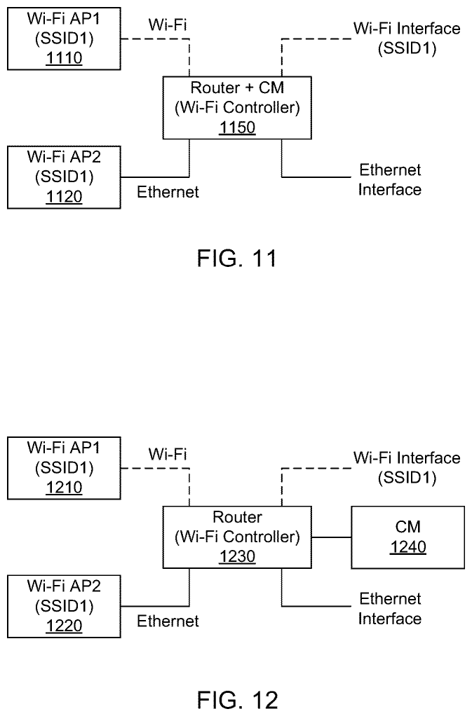

Examples of a single Wi-Fi network are provided herein. If user-owned APs are compliant with some operator requirements, the user-owned APs can be controlled and configured by the Wi-Fi controller on the RG to create a single Wi-Fi network for the user. User Wi-Fi devices can be steered by the controller to connect to the AP providing the best service. The protocol used by the Wi-Fi controller to control and configure Wi-Fi APs may be Wi-Fi Alliance (WFA) EasyMesh or proprietary. Examples of single Wi-Fi networks are shown in FIGS. 11 and 12.

FIG. 11 illustrates an example of a one-box model RG and a Wi-Fi Mesh using the same SSID, controlled and steered by a Wi-Fi controller. As a one-box model, both the router and CM are integrated inside one physical box 1150. The router and CM 1150 may include a Wi-Fi controller and have Wi-Fi access via an Wi-Fi interface using SSID1, and Ethernet access via an Ethernet interface. Further, the router and CM 950 have Wi-Fi access to a user-owned Wi-Fi AP1 1110 using SSID1, and Ethernet access to a user-owned Wi-Fi AP2 1120 using SSID1.

FIG. 12 illustrates an example of a two-box model RG and a Wi-Fi Mesh using the same SSID, controlled and steered by a Wi-Fi controller. The router 1230 and the CM 1240 are in two separate physical boxes, connected by wireline (e.g., Ethernet). The router 1230 may include a Wi-Fi controller and has Wi-Fi access via an Wi-Fi interface (SSID1) and Ethernet access via an Ethernet interface. Further, the router 1230 has Wi-Fi access to a user-owned Wi-Fi AP AP1 1210 using SSID1, and Ethernet access to a user-owned Wi-Fi AP2 1220 using SSID1.

The local Wi-Fi controller in the RG provides the functionality to onboard APs onto the network and manage APs. The controller receives metrics and capability data from APs in the network and controls the operating parameters of those APs, such as channel selection, band steering, client steering and roaming, and backhaul/fronthaul link configuration. It may incorporate standards-based technologies for network management, such as IEEE 802.11k, IEEE 802.11v, and/or IEEE 802.11r.

Additional functionality may include security configuration, client association control, diagnostics, metric and event collection and reporting, service prioritization, and/or network optimization.

Wi-Fi controllers may support APs from a multiple-vendor ecosystem; e.g., using Wi-Fi EasyMesh [EasyMesh]. Wi-Fi controllers may also be cloud based.

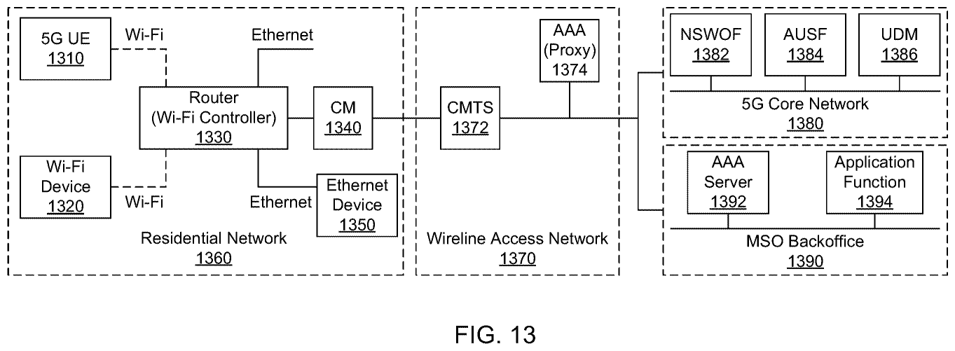

FIG. 13 illustrates an example of network architecture converged with a 5G core network. Embodiments and examples provided here may use the end-to-end architecture of FIG. 13. Similar to the examples above, in a residential network 1350 in FIG. 13, a router 1330 and the CM 1340 are in two separate physical boxes, connected by wireline (e.g., Ethernet). The router 1330 may include a Wi-Fi controller and has Wi-Fi access with a 5G UE 1310 and a Wi-Fi-Device 1320 via an Wi-Fi interface and Ethernet access via an Ethernet interface. Further, the router 1330 has Ethernet access to an Ethernet device 1350.

Also, the CM 1340 may connect with a cable modem termination system (CMTS) 1340, in a wireline access network 1370, via a wireline. The CMTS 1340 may also connect with a proxy 1374, which may be an AAA proxy in the network 1370.

Moreover, the network 1370 may connect with the 5G core network 1380 and a multiple-system operator (MSO) backoffice 1390. The 5G core network 1380 includes a non-seamless WLAN offload function (NSWOF) 1382, an authentication server function (AUSF) 1384, and a unified data management (UDM) 1386 function. Further, the MSO backoffice 1390 includes an AAA server 1392 and an application function 1394.

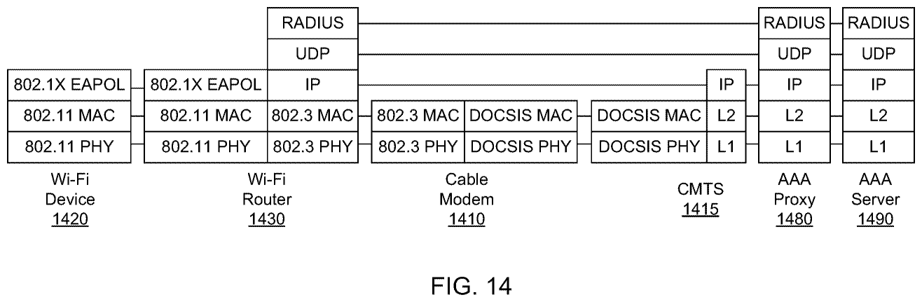

FIG. 14 illustrates an example of a protocol stack for a control plane for EAP-based authentication of Wi-Fi devices directly connected to the Wi-Fi router. As shown in an example in FIG. 14, a higher layer may refer to one or more layers in a protocol stack, or a specific sublayer within the protocol stack. The control plane protocol stack may include one or more layers in a Wi-Fi-device 1420, Wi-Fi router 1430, cable modem 1410, CMTS 1415, AAA proxy 1480 and AAA server 1490. Each layer may have one or more sublayers. Each layer/sublayer may be responsible for one or more functions.

As shown in an example in FIG. 14, the control plane protocol stack in the Wi-Fi device 1420 may include one or more of 802.1X EAP over LAN (EAPoL), 802.11 MAC, and 802.11 PHY; in the Wi-Fi router 1430 may include one or more of 802.1X EAPoL, 802.11 MAC, 802.11 PHY, Remote Authentication Dial In User Service (RADIUS), UDP, IP, 802.3 MAC, and 802.3 PHY; in the CM 1410 may include one or more of 802.3 MAC, 802.3 PHY, DOCSIS MAC and DOCSIS PHY; in the CMTS 1415 may include one or more of DOCSIS MAC, DOCSIS PHY, IP, L2 and L1; in the AAA proxy 1480 may include one or more of RADIUS, UDP, IP, L2 and L1; and in the AAA server 1490 may include one or more of RADIUS, UDP, IP, L2 and L1. Each layer/sublayer may communicate with one or more of the other layers/sublayers, directly or indirectly. In some cases, the aforementioned examples may be called layers/sublayers themselves irrespective of layer number, and may be referred to as a higher layer as described herein. As noted above, any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

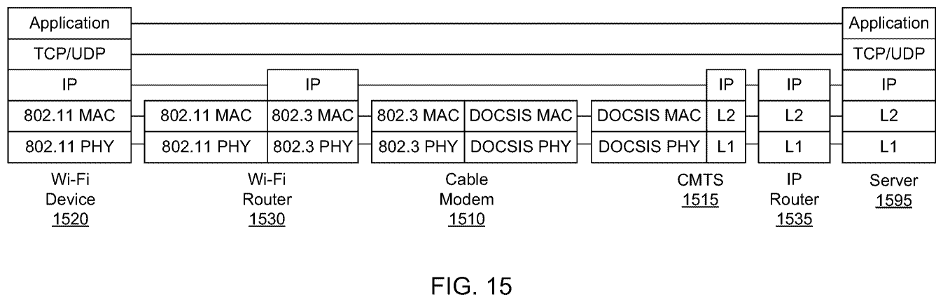

FIG. 15 illustrates an example of a protocol stack for a user plane for Wi-Fi devices connected directly to the Wi-Fi router. The user plane protocol stack may include one or more layers in a Wi-Fi-device 1520, Wi-Fi router 1530, cable modem 1510, CMTS 1515, IP router 1535 and server 1595. As above, each layer may have one or more sublayers. Each layer/sublayer may be responsible for one or more functions.

As shown in an example in FIG. 15, the control plane protocol stack in the Wi-Fi device 1520 may include one or more of an application layer, TCP/UDP, IP, 802.11 MAC, and 802.11 PHY; in the Wi-Fi router 1530 may include one or more of 802.11 MAC, 802.11 PHY, IP, 802.3 MAC, and 802.3 PHY; in the CM 1510 may include one or more of 802.3 MAC, 802.3 PHY, DOCSIS MAC and DOCSIS PHY; in the CMTS 1515 may include one or more of DOCSIS MAC, DOCSIS PHY, IP, L2 and L1; in the IP router 1535 may include one or more of IP, L2 and L1; and in the AAA server 1490 may include one or more of the application layer, IP, L2 and L1. As above, each layer/sublayer may communicate with one or more of the other layers/sublayers, directly or indirectly. In some cases, the aforementioned examples may be called layers/sublayers themselves irrespective of layer number, and may be referred to as a higher layer as described herein. As noted above, any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Currently, a user of a device may have different subscription in different subscription databases in an MSO network. In an example, the MSO network may include one or more of a 3GPP, Wi-Fi, or wireline (Ethernet) network.

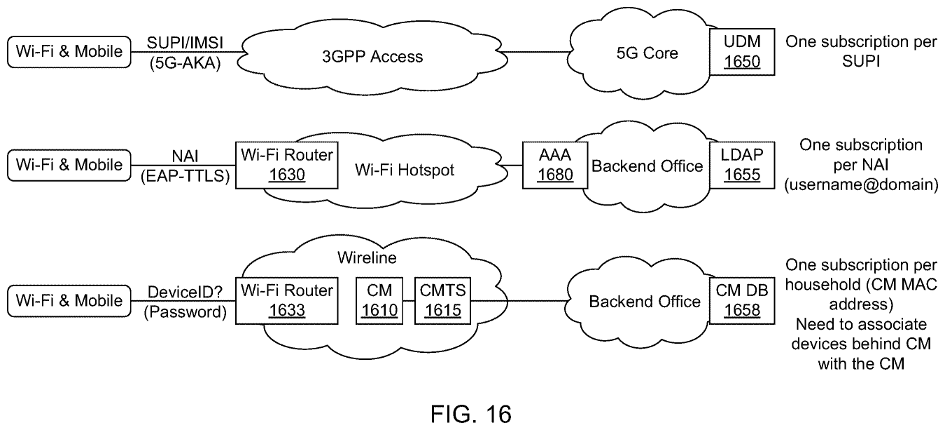

FIG. 16 illustrates an example of different subscription databases in an MSO network. As shown in an example in FIG. 16, an MSO network may include three different types of subscription databases: a UDM/unified data repository (UDR) 1650, which may subscription permanent identifier (SUPI) based; a Microsoft (MS) lightweight directory access protocol (LDAP) 1655, which may be network (NAI) based; and a CM database 1658, which may be an HFC database and which may be CM-MAC based.

As seen above, the UDM 1650 may be located in the 5G core and may contain one subscription per SUPI for a Wi-Fi or mobile device. The 5G core may be reached via 3GPP access by the Wi-Fi or mobile device. The Wi-Fi or mobile device may use one or more of a SUPI, international mobile subscriber identity (IMSI), or 5G authentication and key agreement (AKA) for identification and authentication via 3GPP access. Also, the LDAP 1655 may be located in a backend office, which may also contain an AAA server 1680, and may contain one subscription per NAI (such as in a username@domain format). The backend office may be reached by a Wi-Fi hotspot by the Wi-Fi or mobile device via a Wi-Fi router 1630. The Wi-Fi or mobile device may use one or more of an NAI or EAP-tunneled transport layer security (TTLS) for identification and authentication via the Wi-Fi hotspot. Moreover, the CM database 1658 may be located in a backend office, which may be reached by a wireline (Ethernet) network via a Wi-Fi router 1633, CM 1610 and CMTS 1615, where the Wi-Fi or mobile device may use a device identifier (DeviceID) or password for identification and authentication. The CM DB 1658 may contain one subscription per household (for example a CM MAC address), and may need to associate devices behind the CM with the CM.

The three types of subscriptions may be associated, for example, via an out of band mechanism. For example, a mobile subscription and HFC internet subscription purchased by a same user (with the same billing address) may be associated together. A Wi-Fi hotspot credential (NAI) may be provided to this user, which can also be associated together with mobile and HFC subscriptions. Moreover, device subscription association may be performed in an application (namely association function) on top of separate subscription databases (UDM/UDR, LDAP, HFC).

Further, IEEE 802.11bh, if supported, can be used to identify this mobile device across different sessions. A deviceID may be assigned by an MSO backend office. However, the IEEE 802.11bh deviceID is associated with an SSID, thus the same device will get a different deviceID across Wi-Fi networks (for example, a Wi-Fi hotspot with a public SSID and a private SSID inside a home). Thus, the IEEE 802.11bh does not provide a complete solution to device identification across networks.

Traditionally, MSOs offer internet connectivity services to households regardless of the type of consumer devices inside a house. Because users interact directly with devices and not with residential gateways, user experiences with the network are often determined by how their devices perform and connect to networks.

Device-level services have been the model used by the mobile industry, where a seamless connectivity experience is achieved by service procedures between devices and networks.

Prior procedures have failed to properly address how to identify a Wi-Fi/mobile device as the same device when it uses different identities in different access networks. Embodiments and examples provide solutions herein to allow an MSO to apply the same policy (e.g., parental control, QoS) to this device across different access networks.

Embodiments and examples provided herein define a set of features that allow networks to identify and authenticate consumer devices behind residential gateways (RGs). This enables network operators to provide seamless connectivity and experiences to consumers inside their homes.

Embodiments and examples provided herein consider two types of methods by which a device may be identified and authenticated, including pre-shared key (PSK)-based authentication (aka, password-based authentication) and IEEE 802.1X-based authentication using EAP.

Embodiments and examples provided herein also consider two deployment scenarios of core networks where device subscriptions and credentials are managed: (1) device subscriptions and credentials are managed in 5G core networks and (2) device subscriptions and credentials are managed in multiple-service operators' (MSO) traditional back offices (e.g., a AAA server, Microsoft Active Directory). Whether a device has its own dedicated subscription or is associated with the RG's subscription is an operator's decision.

Identification of devices depends on authentication type. For IEEE 802.1X-based authentication using EAP, a device/subscriber identifier is assigned by the operator, e.g., in the form of IMSI when EAP-AKA′ is used or NAI when EAP-TTLS is used. For PSK-based authentication, device identification is traditionally based on the device's MAC address, which, however, cannot be relied upon in the presence of MAC address randomization. Though IEEE 802.11bh specifies methods for identifying devices using randomized MAC addresses, device identification is limited to an access point (AP) locally. Consistent identification of devices using randomized MAC addresses across operator networks is needed.

Embodiments and examples provided herein consider IEEE 802.1X and EAP-based authentication methods to identify and authenticate devices behind residential gateways. In addition to authentication, embodiments herein also defines an authorization procedure to ensure that only authorized devices are allowed to connect to a private residential gateway. This differs from a community Wi-Fi where a residential gateway, if being part of the community Wi-Fi, accepts any device with valid credentials and subscription from the operator of the community Wi-Fi and their roaming partners.

Embodiments and examples provided herein define features that allow MSOs to identify and authenticate devices behind residential gateways, which is a first step toward providing device-level services that go beyond household-level offerings.

For example, a Mobile Virtual Network Operator (MVNO) could provide a Wi-Fi speed boosting service to its mobile subscribers when the subscribers move to home and connect the mobile devices to home Wi-Fi networks. For another example, a feature defined in embodiments herein would allow home users to grant Wi-Fi access to guest visitors without revealing home Wi-Fi passwords to the visitors. Moreover, embodiments and examples provided herein provide solutions to identify and authenticate a Wi-Fi or mobile device across MSOs which may contain one or more of a 3GPP, Wi-Fi, or wireline (Ethernet) network.

In an example solution to the problems described above, an association function may associate different subscriptions of the same device, for example, based the device fingerprint.

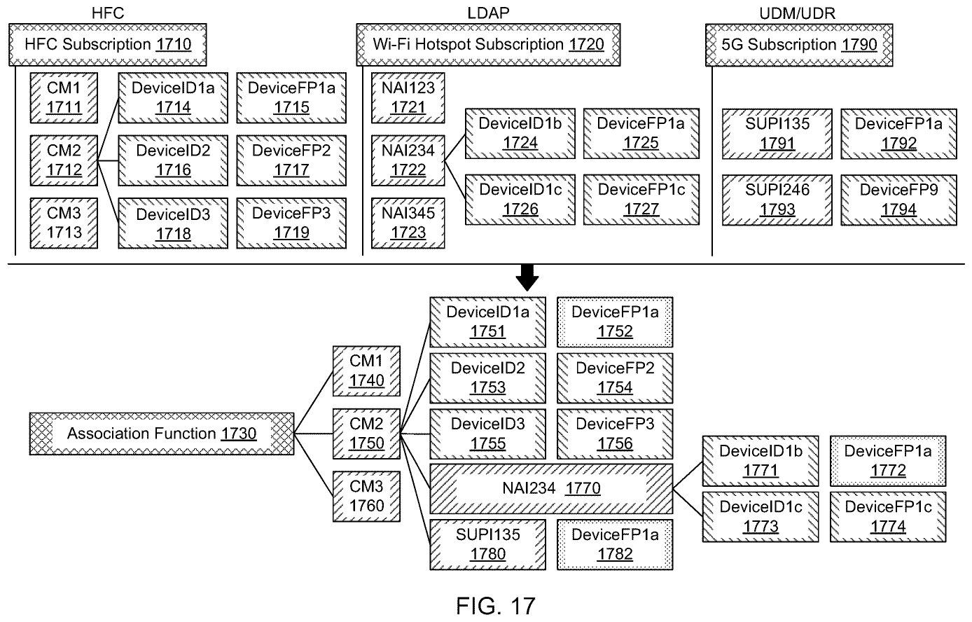

FIG. 17 illustrates an example of an association function to identify a device across network subscription databases. An example in FIG. 17 shows three subscription databases, including an HFC subscription database 1710, a Wi-Fi hotspot subscription database 1720 using LDAP, and a 5G network subscription database 1790 using a UDM/UDR. The HFC subscription database 1710 may include identity information regarding multiple cable modems, such as CM1 1711, CM2 1712, CM3 1713. Further, the Wi-Fi hotspot subscription 1720 may include identity information regarding multiple Wi-Fi devices, each using an NAI, such as NAI123 1721, NAI234 1722, NAI345 1723. Moreover, the mobile 5G network subscription database 1790 may include identity information regarding multiple UEs (which may also be Wi-Fi devices), each using a SUPI, such as SUPI135 1791, SUPI246 1793. Current approaches use separate subscription databases without associating identity information for the same device. For example, NAI234 1722 and SUPI135 1791 are the same device, which is associated with CM2 1712.

In an example solution shown in FIG. 17, an association function 1730 may associate the identities of a device across different subscription databases. For example, association function 1730 may associate mobile 5G network subscriptions with Wi-Fi hotspot subscription. Also, as one of skill in the art understands, a SUPI is unique but an NAI can be shared among devices. Further, when the device connects to a home Wi-Fi, it may not be identified under current approaches.

Accordingly, an association function may assign a deviceID to a Wi-Fi device. Further, IEEE 802.11bh features may be used to assign the deviceID. The contents of IEEE 802.11bh are incorporate herein by reference.

Further, the deviceID in the solution herein may more precisely identity a device as compared with current identity methods. For example, NAI234 1722 may be shared by two devices, each of which has a unique deviceID and fingerprint. As shown in the upper part FIG. 17, one device using NAI234 1722 may use DeviceID1b 1724 and DeviceFP1a 1725, and another device using NAI234 1722 may use DeviceID1c 1726 and DeviceFP1c 1727.

In an example solution shown in the lower part of FIG. 17, a device is fingerprinted after the device establishes a data connection with a network. Each device each device inside a home has a unique fingerprint, in an example. In a further example, the association function 1730 use the fingerprint to associate devices, for example devices which access one or more of CM1 1740, CM2 1750, CM3 1760.

For example, the same fingerprint (DeviceFP1a) is shown as DeviceFP1a 1772 to associate DeviceID1a 1751 (inside a home with CM2 1750), as DeviceFP1a 1772 to associate DeviceID1b 1771 (Wi-Fi hotspot), and as DeviceFP1a 1782 to associate SUPI135 1780; all of which are associated with CM2 1750 (same home). Further, DeviceID2 1753 may use fingerprint DeviceFP2 1754 and DeviceID3 1755 may use fingerprint DeviceFP3 1756. Further, NAI234 may still be shared by two devices. As shown in the lower part of FIG. 17, NAI234 1770 may use the DeviceID1b 1771 and DeviceFP1a 1772, and another device using NAI234 1770 may use DeviceID1c 1773 and DeviceFP1c 1774.

Currently, devices behind an RG can be authenticated directly with the RG using pre-shared keys (e.g., with IEEE 802.11 SAE) or with a backend authentication server using IEEE 802.1X with EAP-based authentication methods. Examples of devices authenticated with IEEE 802.1X are provided in the following.

Two deployment scenarios are described herein: devices being authenticated by 5G core and devices being authenticated by a AAA server. In both scenarios, the Wi-Fi router, a part of the RG, functions as an EAP authenticator and shall support the RADIUS client functionality. The configurations required by RADIUS client, including the IP address of the RADIUS server, the port number of the RADIUS application, and the shared secret with the RADIUS server application, shall be provisioned in the Wi-Fi router by the operator's operations, administration, and management (OAM) system.

The procedure of devices being authenticated by 5G core is based on Annex S of 3GPP TS 33.501 but differs in that it does not always require a Wi-Fi device to construct and send the SUCI to the network. In other words, the procedure is designed to work with both a 5G UE and a 4G UE. The contents of 3GPP TS 33.501 are incorporate herein by reference.

If the Wi-Fi device is not capable of constructing the SUCI (e.g., a 4G UE) and sends an NAI in an EAP identity response to the network, the NSWOF needs to reformulate the NAI to SUPI when making a service call to the AUSF.

This procedure also differs from clause 7B.7 of 3GPP TS 33.501 in that it does not involve the W-AGF and the AMF since the Wi-Fi device is not registered to the 5G core in this procedure.

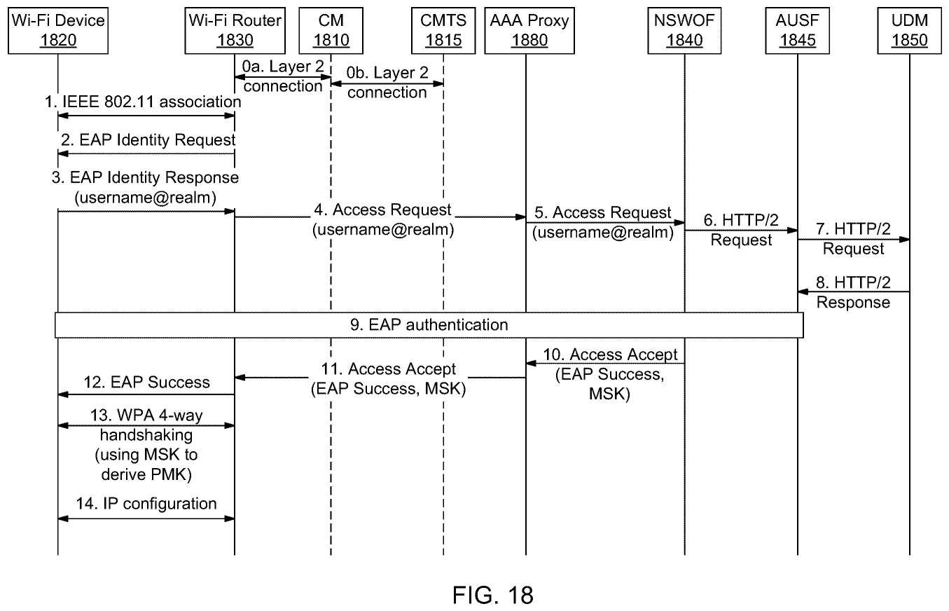

FIG. 18 illustrates an example of a procedure for authenticating a Wi-Fi device by the 5GC. At a step 0, preconditions for the procedure include that the layer 2 connections between a Wi-Fi router 1830 and a CM 1810 (shown in step 0a in FIG. 18) and between the CM 1810 and a CMTS 1815 (step 0b) have been established (not necessarily in order). The Wi-Fi router 1830 shall indicate the support of IEEE 802.1X authentication in its beacon frame and in its probe response frame. The Wi-Fi router 1830 shall use a private SSID.

At a step 1, a Wi-Fi device 1820 establishes an IEEE 802.11 layer 2 association with the Wi-Fi router 1830, after which, IEEE 802.1X authentication can be executed between the Wi-Fi device 1820 and the Wi-Fi router 1830 using the special IEEE 802.11 data frame (i.e., EAPoL).

At a step 2, the Wi-Fi router 1830 shall send an EAP request/identity packet to the Wi-Fi device 1820 in an EAPoL frame.

At a step 3, the Wi-Fi device 1820 shall send back an EAP response/identity packet, including its NAI in the form of “username@realm” to the Wi-Fi router 1830.

At a step 4, the Wi-Fi router 1830 shall send a RADIUS access request message to an AAA proxy 1180, including the NAI of the Wi-Fi device 1820.

Typically, the RADIUS access request message is encapsulated in a DOCSIS layer 2 frame, which includes the MAC address of the CM 1815. Upon receiving this frame, the CMTS 1815 decapsulates the frame and can check binding of the source IP address of the inner IP packet and the source MAC address of the DOCSIS layer 2 frame.

If the binding is valid, the MAC address of the CM 1810 can be included in the RADIUS access request message to allow backend application to validate the binding of device identifier in the EAP layer against the subscription of the RG.

At a step 5, the AAA proxy 1880 shall forward the RADIUS access request message, including the NAI of the Wi-Fi device 1820, to an NSWOF 1840. In examples, the RADIUS access request message can go through multiple AAA proxies before it is received by the NSWOF 1840.

At a step 6, the NSWOF 1840 shall select an AUSF 1845 based on the NAI in the received RADIUS access request message. The NSWOF 1840 shall send a Nausf_UEAuthentication_Authenticate request message to the AUSF 1845, including the NAI of the Wi-Fi device 1820 in SUPI format, and an NSWO indicator. The Nausf_UEAuthentication_Authenticate request message may be included in a hypertext transfer protocol/2 message. The NSWOF 1840 shall set the access network identity to “5G:NSWO”.

At a step 7, the AUSF 1845 shall send a Nudm_UEAuthentication_Get request message to a UDM 1850, including the SUPI of the Wi-Fi device 1820, and the NSWO indicator.

At a step 8, upon reception of the Nudm_UEAuthentication_Get request message, the UDM 1850 shall select EAP-AKA-Prime (EAP-AKA′) as the authentication method based on the SUPI and the NSWO indicator. The UDM/authentication credential repository and processing function (ARPF) shall generate an authentication vector using the access network identity as the key derivation function (KDF) input parameter. The UDM 1850 shall send a Nudm_UEAuthentication_Get response message to the AUSF 1845, including the EAP-AKA′ authentication vector (which may include RAND, AUTN, XRES, CK′, and IK′).

At a step 9, the AUSF 1845 and the Wi-Fi device 1820 shall perform EAP-AKA′ authentication. Upon successful completion of the authentication, the AUSF 1845 shall send a Nausf_UEAuthentication_Authenticate response message with EAP-Success and the master session key (MSK) to the NSWOF 1840.

At a step 10, the NSWOF 1840 shall send a RADIUS access accept message to the AAA proxy 1880, including EAP-Success and the MSK.

At a step 11, the AAA proxy 1880 shall forward the RADIUS access accept message to the Wi-Fi router 1830.

At a step 12, the Wi-Fi router 1830 shall send an EAP-Success message to the Wi-Fi device 1820, encapsulated in an EAPoL frame.

At a step 13, the Wi-Fi device 1820 and the Wi-Fi router 1830 will perform IEEE 802.11 four-way handshaking. The four-way handshaking may be Wi-Fi protected access (WPA) four-way handshaking.

At a step 14, the IP-layer configuration (including the IP address) is provided to the Wi-Fi device 1820, and IP-layer communication can proceed.

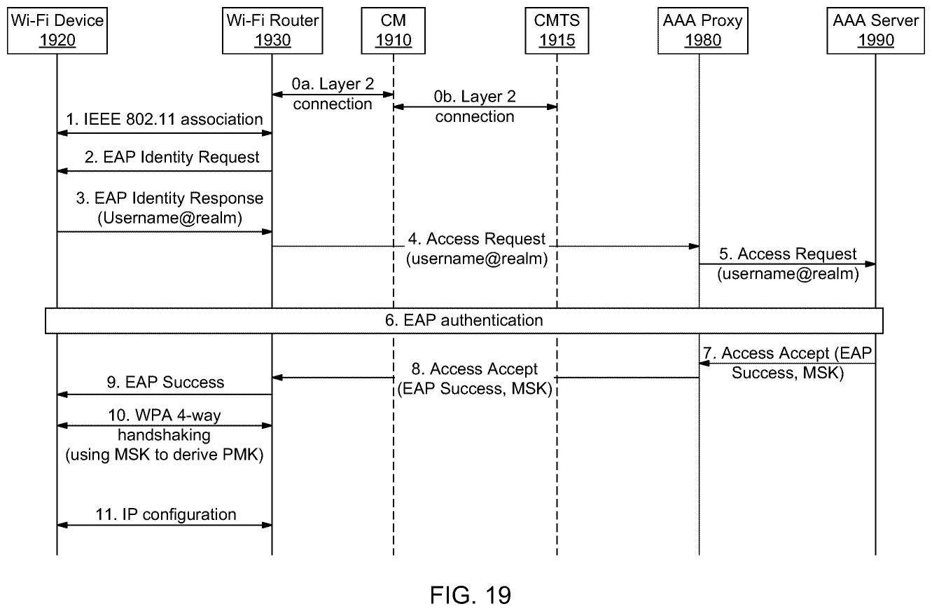

FIG. 19 illustrates an example of a procedure for authenticating a Wi-Fi device by an authentication, authorization, accounting (AAA) server. In steps 0 (steps 0a and 0b) through 4 of FIG. 19 involving a Wi-Fi device 1920, Wi-Fi router 1930, CM 1910, CMTS 1915 and AAA proxy 1980, the procedure is the same as shown in steps 0 through 4 of FIG. 18 and related text.

At a step 5 in FIG. 19, the AAA proxy 1980 proxy shall forward the RADIUS access request message, including the NAI of the Wi-Fi device 1920, to an AAA server 1990. In some examples, the RADIUS access request message can go through multiple AAA proxies before it is received by the AAA server 1990.

At a step 6, the AAA server 1990 and the Wi-Fi device 1920 shall perform EAP authentication.

At a step 7, upon successful completion of the EAP authentication, the AAA server 1990 shall send a RADIUS access accept message with EAP-Success and the MSK key to the AAA proxy 1980.

At a step 8, the AAA proxy shall forward the RADIUS access accept message to the Wi-Fi router, including EAP-Success and the MSK.

In steps 9 through 11 of FIG. 19 involving the Wi-Fi device 1920, Wi-Fi router 1930, CM 1910, CMTS 1915 and AAA proxy 1980, the procedure is the same as shown in steps 12 through 14 of FIG. 18 and related text.

Example solutions of devices authenticated with PSK are provided herein. Further, examples solutions herein include devices with IEEE 802.11bh capabilities. Also, examples solutions herein include devices supporting IEEE 802.11bh device identifiers.

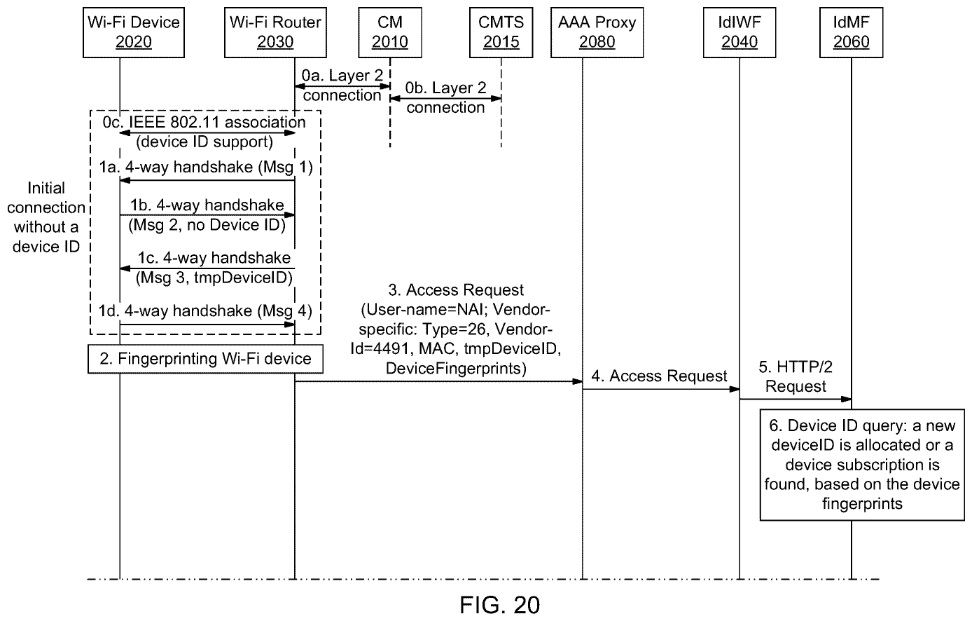

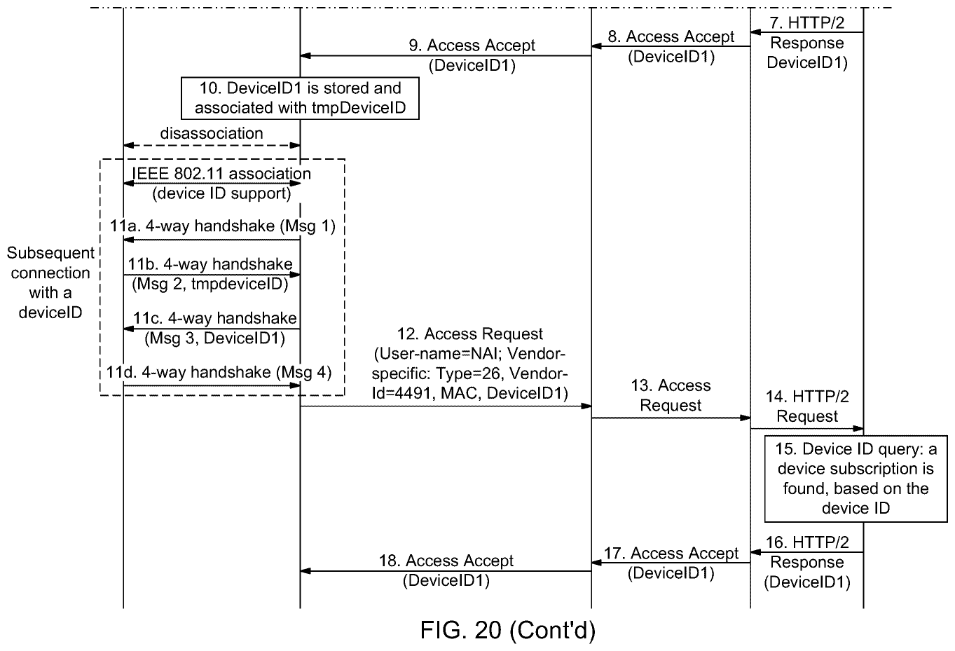

FIG. 20 illustrates an example of a procedure for authenticating a Wi-Fi device supporting an IEEE 802.11bh device identifier. As shown in an example solution in FIG. 20, in step 0a, a layer2 connection between a Wi-Fi router 2030 and a CM 2010 is established. Also, in step 0b, a layer2 connection between the CM 2010 and a CMTS 2015 is established. Further, in step 0c, a Wi-Fi device 2020 and the Wi-Fi router 2030 exchange information regarding IEEE 802.11bh capability of supporting deviceID, and performing authentication and association.

In a step 1a, the Wi-Fi router 2030 starts the 4-way handshaking with the Wi-Fi device 2020 by sending Msg #1.

In a step 1b, the Wi-Fi device 2020 responds with Msg #2, but without including a Device ID in the message.

In a step 1c, the Wi-Fi router 2030 sends a locally generated tmpDeviceId to the Wi-Fi device 2020 in Msg #3 of the 4-way handshake.

In a step 1d, the Wi-Fi device 2020 completes the 4-way handshake with the Wi-Fi router 2030 by sending back the Msg #4.

In a step 2, the Wi-Fi router 2030 performs fingerprinting of the Wi-Fi device 2020.

In examples, the device fingerprinting technique may be performed in different ways. In an example, a consistent fingerprint technique is used across an MSO environment.

In a step 3, the Wi-Fi router 2030 sends a RADIUS Access Request message to an AAA proxy 2080 or AAA server In an example, the RADIUS Access Request message may include CableLabs vendor specific attributes. For example, the RADIUS Access Request message, to request a device ID, may include one or more of a MAC address, tmpDeviceID, Type=26, Vendor-ID=4491, or User-name attribute. In an example, User-name attribute may be in the form of an anonymous NAI (for example, anoymous@domain). In a further example, the Type=26 and Vendor-ID=4491 attributes may be allocated by the Internet Assigned Numbers Authority IANA. Examples of RADIUS attribute definitions are provided further below herein.

In a step 4, the AAA proxy/server 2080 forwards the RADIUS Access Request message to an identification interworking function (IdIWF) 2040.

In a step 5, the IdIWF 2040 sends an HTTP request message to an IdMF 2060 to obtain a Device ID. In examples, different definitions of HTTP request messages may be used. For example, the HTTP request message may be an HTTP/2 request message, as shown in FIG. 20. In another example, the HTTP request message may be an HTTP/1 request message. Moreover, the HTTP request message may be an HTTP/3 request message, in an example.

In an example in step 6, the IdMF 2060 cannot find any device subscription using the tmpDeviceID or fingerprint. Thus, the IdMF 2060 creates a new entry and allocates a new device ID (such as a deviceID1 or deviceID2) for this device. In another example in step 6, the IdMF 2060 finds a device subscription using the tmpDeviceID or fingerprint.

In examples provided herein, different definitions of device ID database schemes may be used.

In a step 7, the IdMF 2060 sends an HTTP response message back to the IdIWF 2040, including a Device ID. In an example where the IdMF 2060 has allocated a new device ID in step 6, the HTTP response message includes the newly assigned DeviceID1 as the Device ID. In an example where the IdMF 2060 found a device subscription, the HTTP response message includes a found device ID associated with the device subscription as the Device ID.

In examples, different definitions of HTTP response message may be used. For example, the HTTP response message may be an HTTP/2 response message, as shown in FIG. 20. In another example, the HTTP response message may be an HTTP/1 response message. Moreover, the HTTP response message may be an HTTP/3 response message, in an example.

In a step 8, the IdIWF 2040 sends a RADIUS Access Accept message to the AAA proxy/server 2080, including the Device ID.

In a step 9, the AAA proxy/server 2080 forwards the RADIUS Access Accept message to the Wi-Fi router 2030.

In a step 10, the Wi-Fi router 2030 stores the Device ID. In an example where the Device ID is DeviceID1, the Wi-Fi router 2030 also associates the DeviceID1 with tmpDeviceID.

In steps 11a-11d, when the Wi-Fi device 2020 disassociated with the Wi-Fi router 2030 and reassociates with it again, the Wi-Fi router 2030 and the Wi-Fi device 2020 perform the 4-way handshaking. The Wi-Fi device 2020 includes the tmpDeviceID in step 11b (Msg #2 of the four-way handshake), and the Wi-Fi router 2030 includes deviceID2 in step 11c (Msg #3 of the four-way handshake).

In steps 12-18, the procedure is same as steps 3-9, except that in step 12, the Wi-Fi router 2030 includes DeviceID1 (instead of tmpDeviceID) in the Access Request message.

Moreover, in an example in step 15, a new device identifier may be allocated after a device subscription is found. This allows a reduction the lifetime of a device identifier. In this way, device and user privacy can be increased.

The example solution shown above and in FIG. 20 provides the ability for an MSO to identify the Wi-Fi/mobile device 2020 as the same device when it uses different identities in different access networks. As a result, the MSO may apply the same policy (for example, parental control, QoS, and so forth) to the Wi-Fi device 2020 across different access networks.

Examples of authenticating Wi-Fi devices supporting IEEE 802.11bh Identifiable Random MAC (IRM) are provided herein.

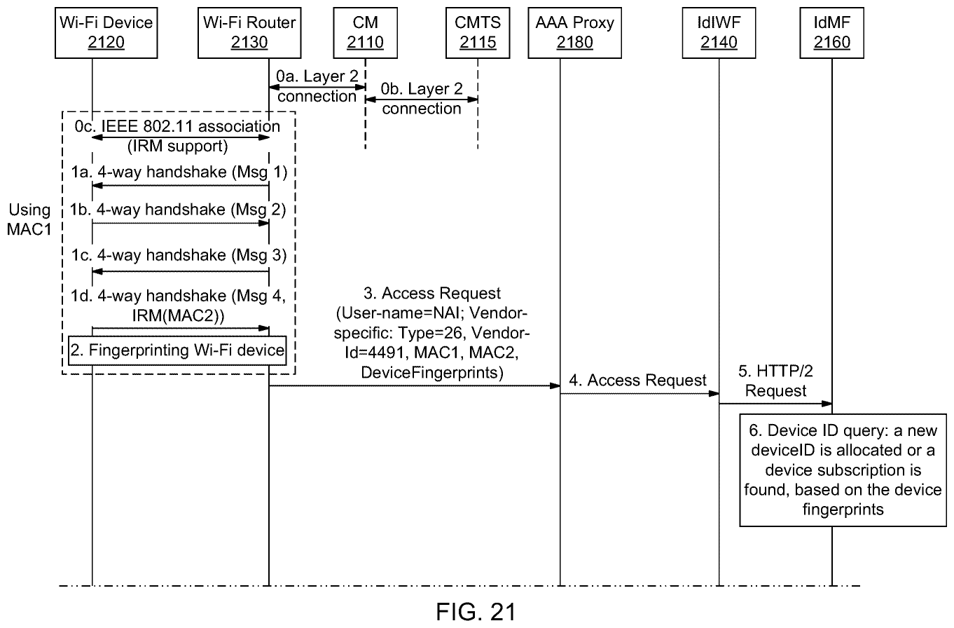

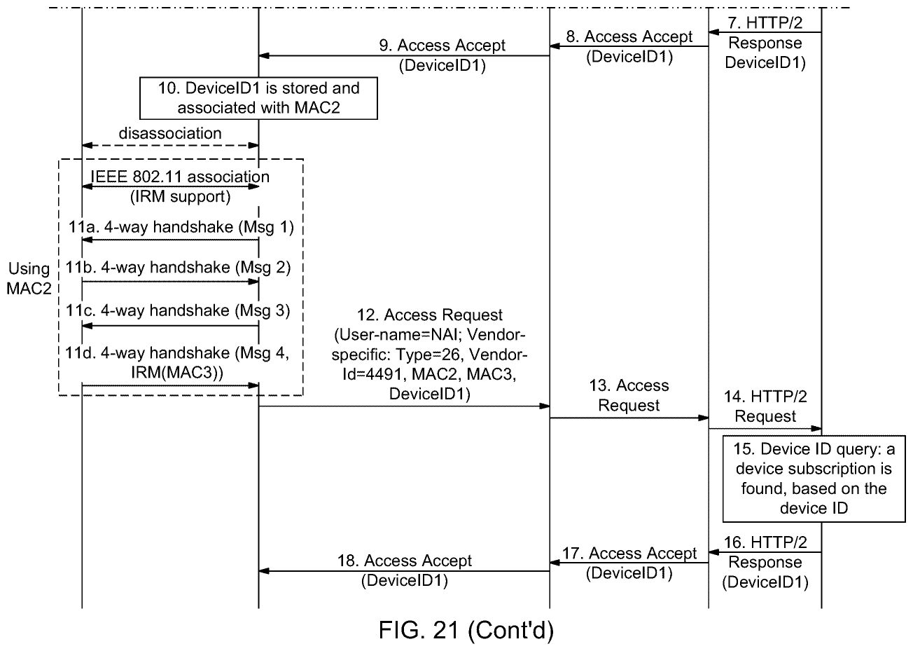

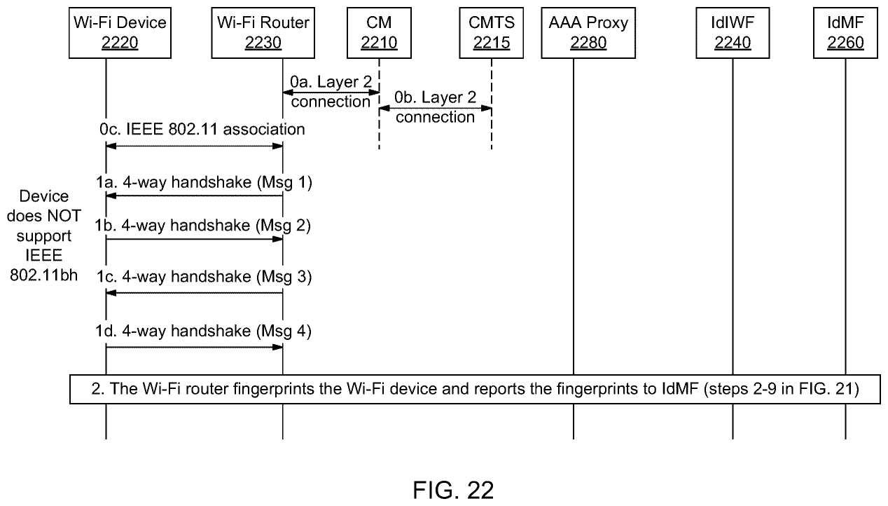

FIG. 21 illustrates an example of a procedure for authenticating a Wi-Fi device supporting IRM. As shown in an example solution in FIG. 21, in step 0a, a layer2 connection between a Wi-Fi router 2130 and a CM 2110 is established. Also, in step 0b, a layer2 connection between the CM 2110 and a CMTS 2115 is established. Further, a Wi-Fi device 2120 and the Wi-Fi router 2130 exchange information regarding IEEE 802.11bh capability of supporting IRM, as shown in step 0c. Further, the Wi-Fi device 2120 and the Wi-Fi router 2130 perform authentication and association.

In steps 1a through 1d, the Wi-Fi router 2130 and the Wi-Fi device 2120 perform the 4-way handshaking. The Wi-Fi device 2120 includes a new MAC address (MAC2) in the Msg #4 (step 1d).

The procedure in steps 2-10 shown in FIG. 21, involving the Wi-Fi router 2130, an AAA proxy 2180, an IdIWF 2140 and an IdMF 2160, is the same as in the procedure in steps 2-10 shown in FIG. 20 and related text, except for steps 3 and 6. As shown in an example in FIG. 21, in step 3, both the current MAC address (MAC1), and the next MAC address (MAC2) are included in the access request message. Also, in step 6 in FIG. 21, both MAC1 and MAC2 are stored and marked as the current and next MAC addresses accordingly.

In steps 11a-11d, when the device Wi-Fi 2120 disassociated with the Wi-Fi router 2130 and reassociate with it again, the Wi-Fi router 2130 and the Wi-Fi device 2120 perform the 4-way handshaking. In step 11d, the Wi-Fi device 2120 includes the a new MAC (MAC3), for example in the last message (Msg4) of the 4-way handshake.

The procedure in steps 12-18 shown is the same as steps 3-9, except for steps 12 and 16. As shown in an example in FIG. 21, in step 12, the Wi-Fi router includes DeviceID1 (instead of device fingerprint), and MAC2 and MAC3 (instead of MAC1 and MAC2) in the Access Request message.

In an example in step 15, a new device identifier may be allocated after a device subscription is found. This allows a reduction the lifetime of a device identifier. In this way, device and user privacy can be increased.

The example solution shown above and in FIG. 21 provides the ability for an MSO to identify the Wi-Fi/mobile device 2120 as the same device when it uses different identities in different access networks. As a result, the MSO may apply the same policy (for example, parental control, QoS, and so forth) to the Wi-Fi device 2120 across different access networks.

FIG. 22 illustrates an example of a procedure for authenticating a Wi-Fi device without IEEE 802.11bh capability. As shown in an example solution in FIG. 22, in step 0a, a layer2 connection between a Wi-Fi router 2230 and a CM 2210 is established. Also, in step 0b, a layer2 connection between the CM 2210 and a CMTS 2215 is established. Further, a Wi-Fi device 2220 and the Wi-Fi router 2230 perform authentication and association without exchanging information regarding IEEE 802.11bh capability of supporting IRM, as shown in step 0c.

In steps 1a through 1d, the Wi-Fi router 2230 and the Wi-Fi device 2220 perform the 4-way handshaking. Further, the procedure in steps 2-10 shown in FIG. 22, involving the Wi-Fi device 2220, the Wi-Fi router 2230, an AAA proxy 2280, an IdIWF 2240 and an IdMF 2260, is the same as in the procedure in steps 2-10 shown in FIG. 21 and related description, except for step 3. As shown in an example in FIG. 22, in step 3, only the current MAC address (MAC1) is included in the access request message.

The example solution shown above and in FIG. 22 provides the ability for an MSO to identify the Wi-Fi/mobile device 2220 as the same device when it uses different identities in different access networks. As a result, the MSO may apply the same policy (for example, parental control, QoS, and so forth) to the Wi-Fi device 2220 across different access networks.

Examples of device fingerprinting are provided herein. In an example, a Wi-Fi router will be capable of performing device fingerprinting for devices. Device fingerprinting consists of collecting a structured set of observable attributes from the device across one or more protocol layers, including, but not limited to: Wi-Fi layer attributes (e.g., supported standards, vendor IEs); DHCP and IP layer behavior (e.g., option sets, TTL values); TLS and application-layer metadata (if available); and Optional behavioral characteristics (e.g., reassociation frequency, DNS patterns).

The fingerprint attributes may be structured in a format such as Type-Length-Value (TLV) or JavaScript object notation (JSON) and transmitted to the IdMF as part of device identification and correlation procedures.

The IdMF will rely solely on cryptographic hashing of full fingerprint data for matching, due to expected variability in attribute values across sessions. Instead, the IdMF will implement a fingerprint comparison function that supports similarity-based matching of new and previously observed fingerprints.

The IdMF may allow multiple fingerprints to be associated with a single Device ID and may support fingerprint evolution over time. Further, the IdMF may request a Device ID from the network for an unknown device, recognize returning devices in future associations, and associate fingerprint data with existing Device IDs or subscriptions.

Additional details regarding fingerprint attributes, matching methods, and representation formats is provided herein further below.

In an example, a common device fingerprinting method is be implemented across an MSO's networks regardless of models and software versions of the Wi-Fi routers. There may be variation in examples applications regarding how often a Wi-Fi router performs device fingerprint for a known device.

In an example, a device connects to the Wi-Fi router, which directs a browser to an invisible fingerprinting page. The page uses Javascript to obtain information from the device. An example of such JS is FingerPrintJS: https://github.com/fingerprintjs/fingerprintjs.

In an example, a minimum set of device attributes as part of the fingerprinting technique may include one or more of: Information obtained from a device (which may include: Device name, OS/firmware version, Browser and version, and Hardware information, e.g., screen resolution, CPU); Network layer fingerprinting (which may include: Wi-Fi radio information can also be obtained from Wi-Fi signal and initial Wi-Fi frames (probe, association, 4-way handshake, etc.), IP layer information, e.g., packet size, packet timing, etc. (e.g., using AI), DHCP requests (particular format) and MAC address (if not randomized or BH is not enabled).

In an example, an operator may deploy different Wi-Fi routers (e.g., from different vendor) which use different fingerprinting techniques. For example, the operator may use Wi-Fi router from X in the home, but from Y and Z in the Wi-Fi hotspot networks.

In this case, Wi-Fi routers X, Y, and Z will generate three different fingerprints X-A, Y-A, and Z-A respectively for a device A. Wi-Fi router information (e.g., vendor, model, OS version, and so forth) that performs the fingerprinting should also be included along with the fingerprint of the device for fingerprint comparison.

Examples of radius attributes related to the embodiments provided herein and described in the following. A Radius message consists of a number of fields, including the code field determining the message type and the attribute fields containing the information to be sent to a recipient. In examples herein, Radius Access Request (code=1), and Access Accept (code=2) message are used.

Among the attributes defined for Radius, this document uses User-Name and Vendor-Specific attributes. An attribute is of the format of Type, Length, and Value, shown below in Table 1. The contents of RFC 2865 are incorporated herein by reference.

TABLE 1

| Type | Attribute | Note |
|---|---|---|
| 1 | User-Name | Defined in clause |
| | | 5.1 of RFC 2865. |
| 26 | Vendor-Specific, | Defined in clause |
| | vendor-Id = 4491 | 5.26 of RFC 2865. |
| | (assigned to | Vendor-specific |
| | CableLabs by | attributes are |
| | IANA). | defined in 7.2 of this |
| | | document. |

Radius attributes which include a vendor type are provided below in Table 2.

TABLE 2

| Vendor- | Vendor- | Vendor-attribute- | |
|---|---|---|---|
| type | length | value | Notes |
| 101 | 2-octet | | Device-Id-Request |
| 102 | 2-octet | | Device-Id-Response |
| 111 | 2-octet | NAI | |
| 112 | 2-octet | SUCI/SUPI | |
| 113 | 2-octet | Device ID (can | Based on IEEE |
| | | be up to 2048 bit | 802.11bh: |
| | | long = 2\hat{ }12) | Device ID length field = 1 |
| | | | octet, Device ID field = |
| | | | variable |
| | | | Device ID length |
| | | | represents the number of |
| | | | octets in the Device Id |
| | | | field. Thus, Device ID be |
| | | | up to 256 (2\hat{ }8) octets. |
| 114 | 1-octet | MAC address[0-4] | Each MAC address is of |
| | | | 48-bit |
| 115 | 1-octet | IPv4 address [0-7] | Each IPv4 address if of |
| | | | 32-bit |
| 116 | 2-octet | IPv6 address[0-511] | Each IPv6 address if of |
| | | | 128-bit |
| 151 | 2-octet | Device Fingerprint | Device fingerprint (DF) |
| | | | should consist of a set of |
| | | | device fingerprint |
| | | | attributes, in the format of |
| | | | DF-Type, DF-Length, and |
| | | | DF-Value. which |
| | | | collectively identify a |
| | | | device. Those sub- |
| | | | attributes are up to |
| | | | implementation. |

Examples of device fingerprint attributes are provided in the following. A Wi-Fi router that performs device fingerprinting, as described herein, will report the fingerprint to the network using a RADIUS attribute, as defined below. This attribute may be included in: RADIUS Access-Request messages (e.g., when requesting a Device ID), and/or RADIUS Accounting-Request messages (e.g., to update the IdMF with fingerprint metadata post-connection). An example attribute format is provided in Table 3, below.

TABLE 3

| Field | Value/Description |
|---|---|
| Type | 26 (Vendor-Specific Attribute) |
| Length | Variable |
| Vendor-Id | 4491 (Assigned to CableLabs by IANA) |
| Vendor-Type | 151 (Device Fingerprint) |
| Vendor-Length | 2 octets + length of fingerprint data |
| Vendor-Data | Encoded fingerprint sub-attributes (see below) |

Examples of sub-attribute format for fingerprint data are provided herein.

The fingerprint attribute may consist of one or more sub-attributes, each encoded in the format:

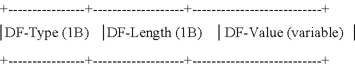

Each sub-attribute represents a fingerprint component such as DHCP options, Wi-Fi capabilities, or TLS ClientHello parameters.

An example DF-Type Registry (Initial Allocation) is provided herein. The registry in Table 4, below, defines example DF-Type values used to encode fingerprint attributes in RADIUS or other fingerprint reporting interfaces. Additional DF-Type values or specific extensions may also be used.

| DF- | | | | Encoding |
|---|---|---|---|---|
| Type | Layer | Attribute Name | Description | Notes |
| 1 | Wi-Fi PHY/ | 802.11 version | Supported Wi-Fi | Bitmask or |
| | MAC | support | protocols | enum list |
| | | | (a/b/g/n/ac/ax) | |
| 2 | Wi-Fi PHY/ | MCS/spatial | Maximum MCS | Integer pair or |
| | MAC | streams | index and | struct |
| | | | spatial streams | |
| 3 | Wi-Fi PHY/ | Transmit power | Advertised max | Integer (dBm) |
| | MAC | capability | transmit power | |
| 4 | Wi-Fi PHY/ | Information | Ordered list of | Byte array |
| | MAC | Elements (IEs) | IEs in | (raw or TLV) |
| | | | probe/assoc | |
| 5 | Wi-Fi PHY/ | Vendor- | OUls and | List of {OUI, |
| | MAC | Specific | content of | Value} |
| | | IEs | vendor | |
| | | | elements | |
| 6 | Wi-Fi PHY/ | SSID list in | SSIDs in active | List of UTF-8 |
| | MAC | probes | scan probes | strings |
| 7 | Wi-Fi PHY/ | Frame timing | Inter-arrival | Integer (ms) |
| | MAC | | timing of frames | or histogram |
| 10 | Network | DHCP Option | Requested | Integer list |
| | Layer | codes | DHCP options | |
| | | | and order | |
| 11 | Network | DHCP User- | Client identifiers | UTF-8 string |
| | Layer | Class/Hostname | via DHCP | |
| 12 | Network | DHCP Vendor | Vendor ID string | UTF-8 string |
| | Layer | Class ID | (Option 60) | |
| 13 | Network | IPv6 behavior | SLAAC or temp | Bitfield or |
| | Layer | | address usage | enum |
| 14 | Network | IP TTL | Initial IP TTL | Integer |
| | Layer | | value | |
| 15 | Network | TCP window | TCP initial | Integer |
| | Layer | size | receive window | |
| 20 | Application | HTTP | Browser or app | UTF-8 string |
| | Layer | User-Agent | User-Agent | |
| | | | string | |
| 21 | Application | TLS | JA3-style | 32-byte hash |
| | Layer | ClientHello | cipher/extension | or list |
| | | | list | |
| 22 | Application | DNS patterns | Queried | List of strings |
| | Layer | | domains after | |
| | | | connect | |
| 30 | Behavioral | Association | Reassociation | Histogram or |
| | | timing | frequency | float |
| | | | patterns | |
| 31 | Behavioral | Packet size | Traffic profile | Profile enum |
| | | patterns | during | or histogram |
| | | | idle/active | |
| 32 | Behavioral | Common | Cloud/service | List of |
| | | destinations | endpoints used | domains/IPs |
| 40 | JS-Based | Screen | Width x Height | Two integers |
| | | resolution | from JS | |
| 41 | JS-Based | Touch/pointer | Touchscreen, | Bitfield |
| | | support | stylus, mouse | |
| 42 | JS-Based | Canvas/WebGL | Browser | 32-byte hash |
| | | fingerprint | rendering | |
| | | | artifacts | |
| 255 | Reserved | — | Reserved for | — |
| | | | future use | |

Examples of an IdMF are provided in the following. The IdMF is a backend function that enables consistent identification, resolution, and correlation of devices across multiple access networks (e.g., residential HFC, Wi-Fi hotspot, and mobile). The example functions in Table 5 may be provided by the IdMF.

TABLE 5

| Function Name | Description |
|---|---|
| Device ID | Allocate a globally unique Device ID for |
| Allocation | a newly observed device |
| Device ID Query | Retrieve the Device ID based on observed |
| | identifiers (IRM, MAC, fingerprint, NAI, etc.) |
| Fingerprint | Match new device fingerprint to existing |
| Matching | fingerprints using similarity scoring |
| Device-to- | Associate a device (Device ID or |
| Subscription | fingerprint) to a user subscription in |
| Association | HFC, Wi-Fi, or mobile systems |
| Device History | Retrieve known identifiers, |
| Lookup | fingerprints, and access events |
| | related to a Device ID |
| Session and | Accept reports on devices (e.g., new |
| environment | IRM, fingerprint, session start/stop) |
| Reporting and | and environment (e.g., Wi-Fi |
| Updates | AP SSIDs, signal strength, etc) |
| | from Wi-Fi routers or gateways |
| Subscriber/Notify | Allow other services to subscriber |
| | to device events and be notified in |
| | real tme when a subscribed event occurs. |

The IdMF exposes a set of service application programming interfaces (APIs) that allow network entities (e.g., Wi Fi routers, AAA proxies, IDIWF) to allocate, resolve, correlate, and maintain device identities across HFC, Wi Fi, and mobile access networks. The APIs operate on the following example identifier types: Device ID, IEEE 802.11bh IRM, MAC address, Device fingerprint, NAI, and SUPI/IMSI.

Examples of device ID allocation are provided in the following. An API description may include: Service Name: Nidf_DeviceID_Allocate; Description: Allocates a globally unique Device ID for a newly observed device when no existing association can be found; Inputs, Required: One or more observed identifiers: IRM (if available), MAC address (if available), Device fingerprint; Input, Optional: subscription context: CM MAC (HFC), NAI (Wi Fi), SUPI/IMSI (Mobile), Access network type (HFC/Wi Fi/Mobile); Outputs, Required: Newly allocated Device ID, Allocation status.

An API example is shown below:

```
POST /device-id/new
Content-Type: application/json
Request:
{
  “accessType”: “HFC”
  “observedIdentifiers”: {
    “macAddress”: “AA:BB:CC:DD:EE:01”,
    “fingerprint”: {
      “dfTypes”: [1, 2, 10, 21]
    }
  },
  “subscriptionContext”: {
    “cmMac”: “00:1A:2B:3C:4D:5E”
    “accountId”: “ACC123456789“
  }
}
Response:
{
  “deviceId”: “dev-8f4a9c32e1”,
  “status”: “allocated“
}
```

A device ID query may be used in an example, which may include an API description of: Service Name: Nidf_DeviceID_Resolve; Description: Retrieves an existing Device ID based on one or more observed identifiers; Inputs, Required: One or more of: Device ID, IRM, MAC address, Device fingerprint, NAI, SUPI/IMSI, Outputs, Required: Resolved Device ID (if found), Match confidence score, Match method (e.g., IRM, fingerprint, NAI). Further, this API will return at most one Device ID. If no confident match exists, the API will indicate “not found” as a result. This API MAY internally invoke fingerprint matching logic.

A Device ID query API example is shown below:

```
POST /device-id/query
Content-Type: application/json
Request:
{
  “observedIdentifiers”: {
    “irm”: “AA:BB:CC:11:22:33”,
    “fingerprint”: {
      “dfTypes”: [1, 10, 21]
    }
  }
}
Response:
{
  “deviceId”: “dev-8f4a9c32e1”,
  “matchConfidence”: 0.93,
  “matchMethod”: “IRM+Fingerprint”
}
Or (if not found)
{
  “deviceId”: null,
  “matchConfidence”: 0.0,
  “match Method”: “none”
}
```

An example of fingerprint matching includes an API with a description of: Service Name: Nidf_DeviceFingerprint_Match; Description: Matches a newly reported device fingerprint against existing fingerprints using similarity scoring; Inputs, Required: Device fingerprint (structured attributes); Inputs, Optional: Optional existing Device ID (if known), Optional access context (RG, AP, SSID); Outputs, Required: Candidate Device ID(s), Similarity score per candidate, Matching decision (match/no match). Further, this API will support tolerant matching (not exact equality). Also, multiple fingerprints may be associated with the same Device ID. Various matching algorithms may be used, in examples.

An example fingerprint matching API is shown below:

```
POST /device-id/match-fingerprint
Content-Type: application/json
Request:
{
  “fingerprint”: [
    {“dfType”: 1, “value”: “802.11ax”},
    {“dfType”: 10, “value”: [1,3,6,15,26,28]},
    {“dfType”: 21, “value”: “ja3:771,4865-
  4866-4867”}
    [
    “accessContext”: {
      “ssid”: “HomeWiFi”,
      “apId”: “RG-001“
    }
  }
  Response:
  {
    “candidates”: [
      {
        “deviceId”: “dev-8f4a9c32e1”,
        “similarityScore”: 0.91
      }
    ],
    “decision”: “match”
  }
```

An example of device-to-subscription association includes an API with a description of: Service Name: Nidf_Device_Subscription_Associate; Description: Associates a device with one or more user subscriptions across access networks; Inputs, Required: Device identifier (Device ID and/or fingerprint), Subscription identifiers (HFC: CM MAC, Account ID, Wi Fi: NAI, Mobile: SUPI/IMSI), Association type (primary/secondary/inferred); Outputs, Required: Association result, Subscription reference(s). A device ID may be associated with multiple subscriptions. The association may be explicit (via authentication) or inferred (via fingerprinting). In an example, the API shall not perform authentications.

An example device-to-subscription association API is shown below:

```
POST /device-id/associate-subscription
Content-Type: application/json
Request:
{
  “deviceId”: “dev-8f4a9c32e1”,
  “subscription”: {
    “type”: “WiFi”,
    “nai”: “alice@wifi.operator.com”
  },
  “associationType”: “explicit”
}
Response:
{
  “associationStatus”: “associated”,
  “subscriptions”: [
    {
      “type”: “WiFi”,
      “nai”: “alice@wifi.operator.com”
    }
  ]
}
```

An example of device history lookup includes an API with a description of: Service Name: Nidf_Device_History_Get; Description: Retrieves historical identifiers, fingerprints, and access events associated with a Device ID; Inputs, Required: Device ID; Outputs, Required: One or more of: Known IRM values, Known MAC addresses, Known fingerprints, Known NAls and SUPIs, Historical access records (timestamps, access type). This API is read-only. Various retention periods may be used, in examples.

An example device history lookup API is shown below:

```
GET /device-id/history?device_id=dev-
8f4a9c32e1
Accept: application/json
Response:
{
  “deviceId”: “dev-8f4a9c32e1”,
  “history”: {
    “irmValues”: [
      “AA:BB:CC: 11:22:33”,
      “AA:BB:CC: 44:55:66”
    ],
    “macAddresses”: [
      “AA:BB:CC:DD:EE:01”
    ],
    “naiValues”: [
      “alice@wifi.operator.com”
    ],
    “fingerprints”: [
      “fp-001”,
      “fp-002“
    ],
    “accessEvents”: [
      {
        “accessType”: “WiFi”,
        “ssid”: “HomeWiFi”,
        “timestamp”: “2026-01-10T14:32:01Z”
      }
    ]
  }
}
```

An example of session and environment reporting and updates includes an API with a description of: Service Name: Nidf_Device_Report_Update; Description: Accepts reports from Wi Fi routers or gateways regarding device sessions and environment context; Inputs, Required: one or more of the following: Device identifier (Device ID, IRM, or fingerprint), Session events (Session start/stop, Association/disassociation), Environment data (optional: SSID, BSSID, Signal strength, AP or RG identifier), Timestamp; Outputs, Required: Acknowledgement; Outputs, Optional: Optional updated Device ID or association result. In an example, the API shall not allocate Device IDs by itself. Further, environment data may be used to enhance fingerprinting and analytics.

An example session and environment reporting and updates API is shown below:

```
POST /device-id/report
Content-Type: application/json
Request:
{
  “deviceIdentifier”: {
    “deviceId”: “dev-8f4a9c32e1”
  },
  “eventType”: “sessionStart”,
  “environment”: {
    “ssid”: “HomeWiFi”,
    “bssid”: “11:22:33:44:55:66”,
    “signalStrength”: -52
  },
  “reportingNode”: {
    “type”: “WiFiRouter”,
    “id”: “RG-001“
  },
  “timestamp”: “2026-01-10T14:32:01Z”
}
Response:
{
  “status”: “accepted”,
  “deviceId”: “dev-8f4a9c32e1”
}
```

An example of subscription and notification services includes an API with a description of: Service Name: Nidf_Subscribe; Description: To subscribe to receive notification of device related events, such as device connection (online) and disconnection (offline) from the network; Inputs, Required: one or more of the following: SubscriberId (A unique identifier of the client), Events (Online/offline), callbackUri (destination for HTTP POST notification URI); Inputs, Optional: filters (DeviceID, Subscription type, Access type); Outputs, Required: SubscriptionId. This API shall not allocate Device IDs by itself. Environment data may be used to enhance fingerprinting and analytics.

An example subscription and notification services API is shown below:

```
POST /idmf/subscribe
{
  “subscriberId”: “WiFi-Speed-Boost-001”,
  “events”: [“device.online”, “device.offline”],
  “callbackUri”: “https://www.example.org/wifi-
speed-boost/events”,
  “filters”: {
    “access Type”: [“Residential”]
  }
}
Response:
{
  “status”: “accepted”,
  “subscriptionId”: “sub-32498fdd”
}
```

In an example, an unsubscriber API may also be used.

Examples of data device models are provided herein. In an example, a device record data model may be used. The below table 6 defines an example of the primary structure of a DeviceRecord, which captures identifiers, fingerprints, network sessions, and associated subscriptions over time.

TABLE 6

| Field | Type | Description |
|---|---|---|
| deviceId | String | Globally unique |
| | | identifier |
| | | assigned by IdMF. |
| currentIdentifiers | Object | Latest observed |
| | | identifiers. |
| historicalldentifiers | List<DeviceIdentifier> | Identifiers r |
| | | observed ove |
| | | time. |
| fingerprints | List<DeviceFingerprint> | Observed device |
| | | fingerprints. |
| networkProfiles | List<NetworkProfile> | Session/ |
| | | environment |
| | | context. |
| subscriptionAssociations | List<SubscriptionLink> | Links to user |
| | | subscriptions. |
| tags | List<String> | Operator-defined |
| | | labels (e.g., |
| | | Guest, BYOD). |
| lastSeen | Timestamp | Last time the |
| | | device was |
| | | observed. |

The following data models define substructures referenced by the DeviceRecord model. These include device identifiers, fingerprints, network sessions, and subscription associations.

The below Table 7 is an example structure which defines the data model for DeviceIdentifier, used as a subcomponent of DeviceRecord.

TABLE 7

| Field | Type | Description |
|---|---|---|
| type | Enum | Identifier type (e.g., mac, |
| | | irm, nai, supi). |
| value | String | The identifier value. |
| firstSeen | Timestamp | First observation |
| | | timestamp. |
| lastSeen | Timestamp | Most recent observation |
| | | timestamp. |
| confidence | Float (0-1) | Confidence level if |
| | | inferred or matched. |

The below Table 8 is an example structure which defines the data model for DeviceFingerprint, used as a subcomponent of DeviceRecord.

TABLE 8

| Field | Type | Description |
|---|---|---|
| fingerprintld | String or Hash | Unique reference or hash |
| | | of fingerprint. |
| attributes | List<FingerprintAttribute> | List of fingerprinted |
| | | attributes. |
| sourceNode | String | Reporting node (e.g., AP, |
| | | RG). |
| timestamp | Timestamp | When the fingerprint was |
| | | collected. |
| matchingScore | Float | Similarity score to known |
| | | Device ID (if matched). |

The below Table 9 is an example structure which defines the data model for FingerprintAttribute, used as a subcomponent of DeviceRecord.

TABLE 9

| Field | Type | Description |
|---|---|---|
| dfType | Integer | DF-Type identifier from |
| | | registry. |
| dfValue | String/List/Object | Actual value for the |
| | | attribute. |
| source Time | Timestamp | Optional timestamp for |
| | | the attribute. |
| stability | Enum | Stability rating (stable, |
| | | variable, volatile). |

The below Table 10 is an example structure which defines the data model for NetworkProfile, used as a subcomponent of DeviceRecord.

TABLE 10

| Field | Type | Description |
|---|---|---|
| accessType | Enum | Access network type |
| | | (HFC, WiFi, Mobile). |
| macAddress | String | MAC address observed. |
| ipAddress | String | IP address assigned. |
| ssid | String | SSID used (Wi-Fi only). |
| bssid | String | BSSID/AP MAC (Wi-Fi |
| | | only). |
| signalStrength | Integer | Signal strength in dBm. |
| sessionStart | Timestamp | Session start time. |
| sessionEnd | Timestamp | Session end time |
| | | (optional). |
| reportingNode | String | Device reporting the |
| | | session (AP, RG, etc.) |

The below Table 11 is an example structure which defines the data model for SubscriptionLink, used as a subcomponent of DeviceRecord.

TABLE 11

| Field | Type | Description |
|---|---|---|
| subscriptionType | Enum | Type of subscription |
| | | (HFC, WiFi, Mobile). |
| subscriberld | String | User or account identifier |
| | | (e.g., NAI, SUPI). |
| associationMethod | Enum | How association was |
| | | made (explicit, inferred, |
| | | manual). |
| confidence | Float | Confidence level in |
| | | association. |
| associatedAt | Timestamp | Timestamp of |
| | | association. |
| expiresAt | Timestamp | Optional expiration |
| | | timestamp. |

Examples of the IDIWF are provided in the following. The IDIWF interfaces the WLAN access network using the RADIUS protocol and interfaces with the IDMF using the API interfaces (such as in the above examples) by performing protocol translation.

The IDIWF receives a RADIUS Access Request message, and translate it into Nidmf_Device_Identifier_Query API provided by the IDMF, in an example. After receiving a response message from the IDMF, the IDIWF translates it to a RADIUS Access Accept message.

Example requirements for devices or nodes used in embodiments and examples herein are provided in the following. The below Table 12 provides example Wi-Fi device requirements.

TABLE 12

| Requirement ID | Description |
|---|---|
| DEV_AUTH_01 | A device may support USIM or eSIM. |
| DEV_AUTH_02 | A device shall support IEEE 802.1x |
| | with EAP [RFC 3748]. |
| DEV_AUTH_03 | If a device supports USIM or eSIM, |
| | the device shall support EAP- |
| | AKA′ [RFC 9048]. |
| DEV_AUTH_04 | The device shall support EAP-TLS |
| | [RFC 5216] and EAP-TTLS |
| | [RFC 5281] with MS-CHAP-v2 [RFC 2759]. |
| DEV_AUTH_05 | The device should support EAP-TEAP [RFC 7170]. |

The below Table 13 provides example RG requirements.

TABLE 13

| Requirement ID | Description |
|---|---|
| RG_01 | The RG shall support [IEEE 802.1X] |
| | and EAP [RFC 3748]. |
| RG_02 | The RG shall support RADIUS |
| | [RFC 2865] client function. |
| RG_03 | The RG should support RADIUS |
| | [RFC 2865] proxy function. |
| RG_04 | The RG shall support WPA3-Enterprise [WPA3]. |
| RG_05 | The RG shall support WPA3-Personal [WPA3]. |

The below Table 14 provides example 5G core requirements.

TABLE 14

| Requirement ID | Description |
|---|---|
| NSWOF_01 | NSWOF shall be able to reformulate |
| | an NAI to SUPI when calling |
| | Nausf_UEAuthentication_Authenticate request. |
| AUSF_01 | Requirements are in addition to those defined by 3GPP. |
| AUSF 02 | The AUSF shall support EAP-AKA′ [RFC 9048]. |
| UDM | If a device supports USIM or eSIM, |
| | EAP-AKA′ [RFC 9048] should |
| | be used to authenticate to the network. |

The below Table 15 provides example AAA requirements.

TABLE 15

| Requirement ID | Description |
|---|---|
| AAA_01 | The AAA shall support RADIUS [RFC 2865]. |
| AAA_02 | The AAA shall support EAP framework [RFC 3748]. |
| AAA_03 | The AAA shall support EAP-TLS |
| | [RFC 5216] and EAP-TTLS [RFC 5281]. |
| AAA_04 | The AAA should support EAP-TEAP [RFC 7170]. |
| AAA_05 | The AAA proxy shall be able to |
| | route a RADIUS message to either |
| | NSWOF toward 5G core or another |
| | AAA proxy/server toward MSO backend |
| | office based on device identifier and/or policy |
| | configuration. |

Various configurations of RGs, including Wi-Fi routers and CMs, may be used with the embodiments and examples provided herein. An example configuration of SSIDs, and EAP authentication methods, is provided below in Table 16.

TABLE 16

| | Public/ | | | |
|---|---|---|---|---|
| | Enterprise | Community | Residential | |
| | Wi-Fi | Wi-Fi | Wi-Fi | |
| SSIDs | Public SSIDs | Public SSIDs | Private SSID | Private SSID |
| | managed by | on residential | on residential | on residential |
| | the operator | RGs managed | RG, managed | RG, managed |
| | | by the | by end users | by operator |
| | | operator | | |
| Authen- | IEEE 802.1X | IEEE 802.1X | IEEE 802.11 | IEEE 802.1X |
| tication | with EAP | with EAP | PSK based | with EAP |
| methods | authentication | authentication | authentication, | authentication |
| | (e.g., EAP- | (e.g., EAP- | such as SAE | (e.g., EAP- |
| | AKA′, | AKA′, EAP- | | AKA′, EAP- |
| | EAP-TLS, | TLS, EAP- | | TLS, EAP- |
| | EAP-TTLS) | TTLS) | | TTLS) |

Examples provided herein include devices behind residential gateways are identified and authenticated, and how a device behind the residential gateway is associated with the device's other subscriptions such as mobile subscription, Wi-Fi hotspot subscription. Examples herein support the use of 802.11 PSK and 802.1X and EAP-based authentication methods.

In prior approaches, devices authenticated with PSK by AP, not by the core network, received a global unique identifier from the network, which are used to provide differential services to the device. This device identifier can be shared with other devices to obtain unauthorized services, since the identifier is not authenticated by the network.

The faults of the prior approaches may be mitigated by device fingerprinting, as shown in examples provided herein. Network monitoring can also mitigate the risks. For example, the network can detect devices with a duplicate device identifier used at the same time.

Further, device fingerprinting should minimize the collection and retention of unnecessary attributes and should comply with applicable privacy regulations. Operators should ensure that fingerprint data is used only for legitimate operational purposes such as device identification, fraud detection, or service personalization.

Examples of subscription databases are provided herein. The following includes example data models for subscription databases used in different access network types. These models illustrate how device identifiers (e.g., MAC address, Device ID, IRM, fingerprint) and user identifiers (e.g., NAI, IMSI, SUPI) may be stored and used for identification, policy enforcement, and cross-network association.

The below table 17 provides an informative example of how an HFC subscription database may be structured to support device identification, authentication, and association with cable modem (CM) and residential gateway (RG) contexts. These fields support traditional subscriber provisioning as well as device-aware features defined in this specification (e.g., Device ID assignment, fingerprint correlation, and multi-access network association).

TABLE 17

| Field Name | Data Type | Description | Example Value |
|---|---|---|---|
| cm_mac_ | MAC | MAC address of the | 00:1A:2B:3C:4D:5E |
| address | Address | cable modem | |
| cm_serial_ | String | Manufacturer serial | 1234567890 |
| number | | number | |
| cm_vendor/ | String | Vendor and model | Arris TM1602 |
| model | | name | |
| cm_firmware_ | String | Firmware running on | v5.01.04.2035 |
| version | | the CM | |
| cmts_interface | String | Upstream/ | US1/DS2 |
| | | downstream | |
| | | interface at CMTS | |
| cm_config_file | String | Name of provisioned | cmcfg-GOLD.bin |
| | | DOCSIS config file | |
| provisioning_ | Enum | Current authorization | Authorized |
| status | | state (Authorized, | |
| | | Quarantine, Denied) | |
| account_id | String | Billing/account | ACC123456789 |
| | | system identifier | |
| subscriber_id | String | Identifier used for | john_ |
| | (NAI | AAA or RADIUS | doe123@cable.net |
| | format) | backend | |
| activation_ | Date | Date the modem was | 2023 Apr. 1 |
| date | | activated or | |
| | | provisioned | |
| service_tier | String | Subscriber's | Internet 1 Gbps |
| | | broadband service | |
| | | tier | |
| qos_profile | Object | Upstream/ | {US: 50 Mbps, |
| | | downstream QoS | DS: 1 Gbps} |
| | | settings | |
| | | (CIR, PIR, priority) | |
| ip_addresses | List of | IPv4 and/or IPv6 | [68.42.123.10, |
| | IPs | addresses | 2001:db8::10] |
| | | provisioned for the | |
| | | RG | |
| ipv6_mode | Enum | Indicates dual-stack | Dual-stack |
| | | or IPv6-only | |
| | | operation | |
| device_class | Enum | Class of service | Residential |
| | | (Residential, | |
| | | Business, Guest, | |
| | | etc.) | |
| rg_mac_ | MAC | MAC address of the | 00:1B:2C:3D:4E:5F |
| address | Address | residential gateway | |
| rg_capabilities | Bitfield | Indicates RG support | 802.1X = 1, |
| | | for 802.1X, | bh = 0, FP = 1 |
| | | 802.11bh, | |
| | | fingerprinting | |
| connected_ | List of | MAC addresses of | [AA:BB:CC:01, |
| device_macs | MACs | devices connected | AA:BB:CC:02] |
| | | behind the RG | |
| connected_ | List of | Assigned Device IDs | [“dev1234”, |
| device_ids | Strings | for known connected | “dev5678”] |
| | | devices | |
| connected_ | List of | Optional fingerprints | [“SHA512(x1)”, |
| device_ | Hashes | observed and stored | “SHA512(x2)”] |
| fingerprints | | for connected | |
| | | devices | |
| ssid_config | Object | SSID name, | {SSID: Home123, |
| | | authentication type, | WPA3: Enabled} |
| | | and security mode | |
| last_seen_ | Timestamp | Most recent activity | 2025-12-20T14: |
| timestamp | | observed from the | 32:01Z |
| | | CM or RG | |

The cm_mac_address acts as the unique key for the cable modem in the subscription database. The connected_device_ids and connected_device_fingerprints fields enable downstream device tracking and are essential for the Device Identification Function (IDF). The rg_capabilities field enables the network to determine whether advanced identification techniques (e.g., IEEE 802.11bh or fingerprinting) are supported at the residential gateway.

Examples of a Wi-Fi hotspot subscription database are provided in the following. Wi-Fi hotspot subscriptions are typically stored in an AAA server or directory service (e.g., LDAP). Each subscription may include one or more user and device identifiers, authentication credentials, and policies for access control or differentiated services.

TABLE 18

| | Data | | |
|---|---|---|---|
| Field Name | Type | Description | Example Value |
| subscriber_id | String | User identifier | alice@wifi. |
| | (NAI) | in the form | operator.com |
| | | username@realm | |
| authentication_ | Enum | EAP method | EAP-TTLS |
| method | | used (e.g., EAP-TLS, | |
| | | EAP-TTLS, | |
| | | EAP-AKA′) | |
| eap_credentials | Object | Certificates, | certID = 123, |
| | | passwords, or | MSCHAPv2 |
| | | SIM credentials | hash |
| associated_ | List of | List of assigned or | [“dev001”, |
| device_ids | Strings | observed Device IDs | “devX45”] |
| device_irm_ | List of | IEEE 802.11bh IRM | [“AA:BB:CC: |
| values | MACs | values observed from | 00:11:22”] |
| | | devices | |
| device_ | List of | Optional list of stored | [“SHA512(fp1)”, |
| fingerprints | Hashes | device fingerprints | SHA512(fp2)”] |
| mac_address_ | List of | Optional static MAC | [“DE:AD:BE: |
| whitelist | MACs | address list for | EF:00:01”] |
| | | known devices | |
| access_policy | Enum | Access policy | Standard, |
| | or | assigned to the | |
| | Object | user or device | Priority, Guest |
| session_limits | Object | Rate, time, and data | 1 hour/1 GB/ |
| | | volume limits | 50 Mbps |
| last_seen_device | Struct | Info about last | {ID: devX45, IRM: |
| | | connected device | XX:XX . . . , t: T} |
| | | (Device ID, IRM, | |
| | | timestamp) | |
| realm_affiliation | String | Operator or roaming | wifi.operator.com |
| | | partner realm | |
| roaming_policy | Enum | Access rights when | WFA-Passpoint, |
| | or List | roaming | visited partners |

Table 18

Examples of a mobile network subscription database are provided in the following. Mobile subscriptions are managed in 5G core using the Unified Data Repository (UDR) and accessed by the UDM. Devices are identified using SUPI/IMSI, but may also be associated with Wi-Fi identifiers for offload or convergence.

| | Data | | |
|---|---|---|---|
| Field Name | Type | Description | Example Value |
| supi/imsi | String | Subscription | imsi- |
| | | Permanent | 310150123456789 |
| | | Identifier (5G/4G) | |
| authentication_ | Enum | Mobile authentication | EAP-AKA′ |
| method | | method (e.g., | |
| | | EAP-AKA′) | |
| authentication_ | Object | Stored authentication | {CK, IK, RAND, |
| vector | | vector or generation | AUTN, XRES} |
| | | keys | |
| nai_alias | String | NAI used when device | supi@operator.com |
| | | authenticates via | |
| | | Wi-Fi (e.g., in EAP) | |
| msisdn | String | Mobile subscriber | +15551234567 |
| | | phone number | |
| | | (if assigned) | |
| device_id | String | Persistent Device | dev9876 |
| | | ID used across | |
| | | Wi-Fi/mobile | |
| known_irm_ | List of | IRM values from | [“AA:BB:CC: |
| values | MACs | Wi-Fi connections | DE:AD:01”] |
| device_ | List of | Observed fingerprints | [“SHA512(x1)”] |
| fingerprints | Hashes | (e.g., from Wi-Fi | |
| | | offload sessions) | |
| capability_ | Object | Device features (e.g., | NR = yes, |
| profile | | 5G/NR, VoLTE, | Passpoint = yes |
| | | Wi-Fi offload) | |
| data_plan_id | String | Service profile or data | 5G-Unlimited |
| | | plan name | |
| roaming_ | List of | Allowed roaming | [“partner1.com” |
| entitlement | Realms | partners | “partner2.com”] |
| last_wifi_ | Struct | Last known Wi-Fi | {dev9876, |
| offload | | offload session | SSID:Home, T} |
| | | (Device ID, SSID, | |
| | | timestamp) | |

Examples of cross-network considerations are provided in the following. In an example, to enable device association across HFC, Wi-Fi hotspot, and mobile networks: CM MAC must be associated with a device in each access system's subscription database; fingerprints may be used to correlate records when a Device ID is not available; and the IdMF should be capable of querying each subscription store (AAA, UDR, LDAP, etc.) using any known identifier (Device ID, IRM, NAI, SUPI) to enable consistent identification and association.

The following is an example of how a Wi-Fi router may fingerprint a connected device. Device fingerprinting enables the operator to associate transient identifiers (e.g., randomized MAC addresses) with a persistent backend identity, thereby enabling consistent service, monitoring, or policy enforcement across sessions and access networks. Device fingerprinting can be implemented using a combination of Wi-Fi layer, network layer, application layer, and behavioral data collected passively or actively by the Wi-Fi router. Recommend device fingerprint attributes a Wi-Fi router may collect as part of a device fingerprint are provided herein above.

Examples of fingerprint representation and matching are provided herein. Device fingerprint attributes collected by a Wi-Fi router are inherently subject to change over time due to software updates, configuration changes, environmental factors, or normal variations in device behavior. As a result, the use of a simple cryptographic hash function over the complete set of fingerprint attributes is not recommended as the sole mechanism for device identification, since any change in input may result in a different hash value for the same physical device. Instead, device fingerprinting is intended to support probabilistic and tolerant matching rather than exact matching.

A device fingerprint should be represented as a structured set of attributes, for example using a Type-Length-Value (TLV) or JSON-based format. Each attribute represents an observable characteristic of the device (e.g., Wi-Fi capabilities, DHCP behavior, TLS fingerprint). Attributes MAY be classified into categories based on their expected stability, for example: Relatively stable attributes (e.g., supported 802.11 standards, MCS capabilities, DHCP option list); Moderately variable attributes (e.g., TLS ClientHello parameters, IPV6 behavior); and Highly variable attributes (e.g., frame timing, traffic patterns).

The Device Identification Management Function (IdMF) should implement a fingerprint matching function that compares two fingerprints and returns a similarity score rather than performing a strict equality check. Conceptually, this function can be expressed as:
score=F(fingerprint_A, fingerprint_B)
where: F( ) is a similarity or classification function, fingerprint_A is a newly observed fingerprint, and fingerprint_B is a stored fingerprint associated with an existing Device ID.

A fingerprint may be associated with an existing Device ID if the similarity score exceeds a configurable threshold defined by operator policy. In an example, the similarity function may be implemented using rule-based matching, weighted scoring, statistical methods, or machine-learning-based classifiers.

Examples of fingerprint stability and consistency are provided herein. An example procedure may derive a stable composite fingerprint using a subset of attributes that are expected to vary infrequently. Examples include: Wi-Fi PHY/MAC capability sets, DHCP option lists and ordering, and TLS ClientHello fingerprint (cipher suites and extensions).

This composite fingerprint may be serialized in a deterministic manner and hashed (e.g., using SHA-256) to produce a semi-persistent identifier that can be used as an index or lookup key within the IdMF. In an example, such a composite identifier is not expected to be globally unique and should be used only as an aid to fingerprint matching, not as a definitive device identifier.

Examples of fingerprint evolution and association are provided herein. The IdMF should allow multiple fingerprints to be associated with a single Device ID to accommodate: software or firmware upgrades; changes in network configuration; and differences in observations across access networks (e.g., residential Wi-Fi vs. hotspot Wi-Fi). When a new fingerprint is determined to belong to an existing device, the IdMF may store the new fingerprint and associate it with the same Device ID for future matching.

Examples of fingerprint consistency across deployments are provided herein. To enable consistent device identification across an operator's infrastructure (e.g., home Wi-Fi, hotspots, community Wi-Fi), the following are recommended: a standardized fingerprinting schema shared across all Wi-Fi routers; a common fingerprint-to-DeviceID resolution method (via IdMF); and inclusion of router metadata (e.g., model, software version) to aid in comparing fingerprints generated by different platforms.

Examples herein may use differentiated services which enables policy enforcement or service personalization based on device type or class (e.g., guest vs. household device). Further, examples herein may use location services to allow the procedure to check if a device is currently at home.

In an example, a first network node generates an access request message. In an example, the access request message includes one or more device identifiers including: a MAC address for the device, an IP address for the device, an NAI for the device, a first IEEE 802.11bh device identifier (device ID) for the device, a mobile subscription identifier, or a fingerprint for the device. Further, the first network node sends, to a second network node, the access request message.

Also, the second network node receives, from the first network node, the access request message, and forwards, to a third network node, the access request message. In addition, the third network node receives, from the second network node, the access request message.

Additionally or alternatively, the third network node allocates, based on network policy and on a determination that no subscription of the device is found, a second IEEE 802.11bh device identifier for the device. Additionally or alternatively, the second IEEE 802.11bh device identifier for the device is a network wide identifier. Further, the third network node generates an access response message. Additionally or alternatively, the access response message includes the second IEEE 802.11bh identifier for the device. Additionally or alternatively, the third network node sends, to the second network node, the access response message.

Additionally or alternatively, the second network node receives, from the third network node, the access response message, and forwards, to the first network node, the access response message. Additionally or alternatively, the first network node receives, from the second network node, the access response message. Additionally or alternatively, the first network node stores the second IEEE 802.11bh device identifier for the device and associates the second IEEE 802.11bh device identifier for the device with the first IEEE 802.11bh device identifier for the device or a MAC information element (IE) for the device.

Additionally or alternatively, the first network node is a Wi-Fi router, the second network node is a proxy, the third network node is an IdMF, and the device is a UE. Additionally or alternatively, the Wi-Fi router includes an AP, and the UE is a Wi-Fi device. Additionally or alternatively, the proxy is an AAA proxy, and a fourth network node is used in between the second network node and the third network node.

Additionally or alternatively, the access request message sent by the second network node to the fourth network node is a RADIUS message, and the access request message sent by the fourth network node to the third network node is one of an HTTP/1 message, an HTTP/2 message, or an HTTP/3 message. Additionally or alternatively, the fourth network node is an IdIWF. Additionally or alternatively, the IdIWF performs protocol translation of RADIUS and HTTP between the second and the third network nodes.

Additionally or alternatively, the access request message sent by the first network node and received by the second network node is a RADIUS message, or one of an HTTP/1 message, an HTTP/2 message, or an HTTP/3 message. Additionally or alternatively, the access request message sent by the second network node and received by the third network node is one of an HTTP/1 message, an HTTP/2 message, or an HTTP/3 message.

Additionally or alternatively, the access response message sent by the third network node and received by the second network node is one of an HTTP/1 message, an HTTP/2 message, or an HTTP/3 message.

Additionally or alternatively, the access response message sent by the second network node and received by the first network node is a RADIUS message, or one of an HTTP/1 message, an HTTP/2 message, or an HTTP/3 message.

Additionally or alternatively, the second IEEE 802.11bh device identifier for the device is globally unique. Additionally or alternatively, the second IEEE 802.11bh device identifier for the device is allocated by the IdMF.

Additionally or alternatively, the IdMF performs a similarity-based device fingerprint matching process. Additionally or alternatively, the IdMF receives a device fingerprint represented as a structured set of fingerprint attributes encoded using a type-length-value or structured data format. Additionally or alternatively, the IdMF classifies the fingerprint attributes into stability categories including stable, moderately variable, and highly variable attributes. Additionally or alternatively, the IdMF applies weighted comparison logic to the fingerprint attributes based on the stability categories. Additionally or alternatively, the IdMF computes a similarity score indicative of a likelihood that the device fingerprint corresponds to an existing device subscription. Additionally or alternatively, the IdMF, multiple distinct device fingerprints collected from different access networks or at different times are associable with the same globally unique device identifier.

Additionally or alternatively, the IdMF performs allocating or resolving a device identifier. Additionally or alternatively, the IdMF receives device session or environment reports from network elements indicating changes in device connectivity state. Additionally or alternatively, the IdMF generates and transmits device event notifications to one or more external services that have registered interest in device-related events. Additionally or alternatively, the device event notifications are selectively triggered based on subscription-defined filters or access-network-specific criteria.

In another example, a network node receives a request message, including one or more device identifiers including: a MAC address for the device, an IP address for the device, an NAI for the device, a first IEEE 802.11bh device identifier (device ID) for the device, a mobile subscription identifier, or a fingerprint for the device. Also, the network node allocates, based network policy and on a determination that no subscription of the device is found, a second IEEE 802.11bh device identifier for the device. Additionally or alternatively, the second IEEE device identifier for the device is a network wide identifier. Additionally or alternatively, the allocating is performed via an API exposed by the IdMF. Further, the network node generates a response message. Additionally or alternatively, response message includes the second IEEE 802.11bh identifier for the device. Moreover, the network node sends the response message. Additionally or alternatively, the response message is sent to another network node.

In a further example, a network node receives a request message, including one or more device identifiers including: a MAC address for the device, an IP address for the device, an NAI for the device, a first IEEE 802.11bh device identifier (device ID) for the device, a mobile subscription identifier, or a fingerprint for the device. Also, the network node resolves, based network policy and on a determination that a subscription of the device is found, the IEEE 802.11bh device identifier for the device Additionally or alternatively, the IEEE device identifier for the device is an existing network wide identifier. Additionally or alternatively, the resolving is performed via an API exposed by the IdMF.

Additionally or alternatively, the network node generates a response message. Additionally or alternatively, the response message includes the IEEE 802.11bh identifier for the device. Moreover, the network node sends the response message. Additionally or alternatively, the response message is sent to another network node.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, terminal, base station, RNC, or any host computer.

What is claimed:

1. A system comprising:
a first network node comprising:
a first processor; and
a first communications interface operatively coupled to the first processor; wherein:
the first processor is configured to generate an access request message, wherein the access request message includes one or more device identifiers including: a Medium Access Control (MAC) address for the device, an Internet Protocol (IP) address for the device, a network access identifier (NAI) for the device, a first Institute of Electrical and Electronics Engineers (IEEE) 802.11bh device identifier (device ID) for the device, a mobile subscription identifier, or a fingerprint for the device; and
the first processor and the first communications interface are configured to send, to a second network node, the access request message.

2. The system of claim 1, wherein:
the system further comprises the second network node, wherein the second network node comprises:
a second processor; and
a second communications interface operatively coupled to the second processor; wherein:
the second processor and the second communications interface are configured to receive, from the first network node, the access request message; and
the second processor and the second communications interface are configured to forward, to a third network node, the access request message; and
the system further comprises the third network node, wherein the third network node comprises:
a third processor; and
a third communications interface operatively coupled to the third processor; wherein:
the third processor and the third communications interface are configured to receive, from the second network node, the access request message; and
the third processor is configured to determine whether a subscription of the device is found based on one or more of the device identifiers for the device.

3. The system of claim 2, wherein in the third network node:
the third processor is further configured to allocate, based on network policy and on a determination that no subscription of the device is found, a second IEEE 802.11bh device identifier for the device, wherein the second IEEE 802.11bh device identifier for the device is a network wide identifier;
the third processor and the third communications interface are further configured to generate an access response message, wherein the access response message includes the second IEEE 802.11bh identifier for the device; and
the third processor and the third communications interface are further configured to send, to the second network node, the access response message.

4. The system of claim 3, wherein in the second network node:
the second processor and the second communications interface are configured to receive, from the third network node, the access response message; and
the second processor and the second communications interface are configured to forward, to the first network node, the access response message.

5. The system of claim 4, wherein in the first network node:
the first processor and the first communications interface are further configured to receive, from the second network node, the access response message; and
the first processor is further configured store the second IEEE 802.11bh device identifier for the device and associate the second IEEE 802.11bh device identifier for the device with the first IEEE 802.11bh device identifier for the device or a MAC information element (IE) for the device.

6. The system of claim 3, wherein the first network node is a Wi-Fi router, the second network node is a proxy, the third network node is an identification management function (IdMF), and the device is a user equipment (UE).

7. The system of claim 6, wherein the Wi-Fi router includes an access point (AP), and the UE is a Wi-Fi device.

8. The system of claim 6, wherein the proxy is an authentication, authorization, accounting (AAA) proxy, and a fourth network node is used in between the second network node and the third network node.

9. The system of claim 8, wherein the access request message sent by the second network node to the fourth network node is a remote authentication dial in user service (RADIUS) message, and the access request message sent by the fourth network node to the third network node is one of a hypertext transfer protocol (HTTP)/1 message, an HTTP/2 message, or an HTTP/3 message.

10. The system of claim 8, wherein the fourth network node is an identification interworking function (IdIWF), wherein the IdIWF performs protocol translation of RADIUS and HTTP between the second and the third network nodes.

11. The system of claim 1, wherein the access request message sent by the first network node and received by the second network node is a RADIUS message, or one of an HTTP/1 message, an HTTP/2 message, or an HTTP/3 message.

12. The system of claim 2, wherein the access request message sent by the second network node and received by the third network node is one of an HTTP/1 message, an HTTP/2 message, or an HTTP/3 message.

13. The system of claim 3, wherein the access response message sent by the third network node and received by the second network node is one of an HTTP/1 message, an HTTP/2 message, or an HTTP/3 message.

14. The system of claim 4, wherein the access response message sent by the second network node and received by the first network node is a RADIUS message, or one of an HTTP/1 message, an HTTP/2 message, or an HTTP/3 message.

15. The system of claim 3, wherein the second IEEE 802.11bh device identifier for the device is globally unique.

16. The system of claim 6, wherein the second IEEE 802.11bh device identifier for the device is allocated by the IdMF.

17. The system of claim 6, wherein the IdMF performs a similarity-based device fingerprint matching process, wherein:
the third processor and the third communications interface are further configured to receive a device fingerprint represented as a structured set of fingerprint attributes encoded using a type-length-value or structured data format;
the third processor is further configured to classify the fingerprint attributes into stability categories including stable, moderately variable, and highly variable attributes;
the third processor is further configured to apply weighted comparison logic to the fingerprint attributes based on the stability categories; and
the third processor is further configured to compute a similarity score indicative of a likelihood that the device fingerprint corresponds to an existing device subscription, wherein multiple distinct device fingerprints collected from different access networks or at different times are associable with the same globally unique device identifier.

18. The system of claim 6, wherein the IdMF performs allocating or resolving a device identifier, wherein:
the third processor and the third communications interface are further configured to receive device session or environment reports from network elements indicating changes in device connectivity state; and
the third processor and the third communications interface are further configured to generate and transmit device event notifications to one or more external services that have registered interest in device-related events, wherein the device event notifications are selectively triggered based on subscription-defined filters or access-network-specific criteria.

19. A network node comprising:
a processor; and
a communications interface operatively coupled to the processor; wherein:
the processor and the communications interface are configured to receive a request message, wherein the request message includes one or more device identifiers including: a Medium Access Control (MAC) address for the device, an Internet Protocol (IP) address for the device, a network access identifier (NAI) for the device, a first Institute of Electrical and Electronics Engineers (IEEE) 802.11bh device identifier (device ID) for the device, a mobile subscription identifier, or a fingerprint for the device;
the processor configured to allocate, based network policy and on a determination that no subscription of the device is found, a second IEEE 802.11bh device identifier for the device, wherein the second IEEE 802.11bh device identifier for the device is a network wide identifier, wherein the allocating is performed via an application programming interface (API) exposed by an identification management function (IdMF);
the processor and the communications interface are configured to generate a response message, wherein the response message includes the second IEEE 802.11bh identifier for the device; and
the processor and the communications interface are configured to send the response message.

20. A network node comprising:
a processor; and
a communications interface operatively coupled to the processor; wherein:
the processor and the communications interface are configured to receive a request message, wherein the request message includes one or more device identifiers including: a Medium Access Control (MAC) address for the device, an Internet Protocol (IP) address for the device, a network access identifier (NAI) for the device, a Institute of Electrical and Electronics Engineers (IEEE) 802.11bh device identifier (device ID) for the device, a mobile subscription identifier, or a fingerprint for the device;
the processor configured to resolve, based network policy and on a determination that a subscription of the device is found, the IEEE 802.11bh device identifier for the device, wherein the IEEE 802.11bh device identifier for the device is an existing network wide identifier, wherein the resolving is performed via an application programming interface (API) exposed by an identification management function (IdMF);
the processor and the communications interface are configured to generate a response message, wherein the response message includes the IEEE 802.11bh identifier for the device; and
the processor and the communications interface are configured to send the response message.
